(19) United States
(12) Patent Application Publication
(10) Pub. No.: US 2025/0214045 A1
(43) Pub. Date: Jul. 3, 2025

(54) CONTAINERS INCLUDING INTERNAL MIXERS AND METHODS OF USE

(71) Applicants: Sartorius Stedim Biotech GmbH, Göttingen (DE); Trustees of Boston University, Boston, MA (US)

(72) Inventors: Samin Akbari, Winchester, MA (US); Douglas Holmes, Jamaica Plain, MA (US); Yi Yang, West Newton, MA (US); David James Pollard, Stow, MA (US); Sanika Barve, Mason, OH (US); Alessandro Bailini, Sesto San Giovanni , Milan (IT); Javier Nadal, Warwick (GB)

(73) Assignees: Sartorius Stedim Biotech GmbH, Göttingen (DE); Trustees of Boston University, Boston, MA (US)

(21) Appl. No.: 18/841,916

(22) PCT Filed: Mar. 1, 2023
(86) PCT No.: PCT/US2023/014266

§ 371 Date: Aug. 27, 2024

Related U.S. Application Data
(60) Provisional application No. 63/315,508, filed on Mar. 1, 2022.
(60) Provisional application No. 63/315,495, filed on Mar. 1, 2022.

(51) Int. Cl. B01F 31/44; B01F 35/513

(52) U.S. Cl. CPC B01F 31/449; B01F 35/513

(57) ABSTRACT

Containers including internal mixers and actuators assemblies and related methods are generally described. In some embodiments, a container may include a mixer and an actuator, at least one of which may be located inside of the container. The actuator may actuate the mixer to induce flow within the container and mix the contents of the container with a low volumetric footprint and high mixing efficiency. In some embodiments, the actuator may be configured to deform the mixer, which may include one or more features which may be deformed out of plane in a Kirigami or Origami fashion. The actuator and mixer may be arranged in series or in parallel. The actuator may be used without a mixer to induce flow within the container. The actuator may be driven pneumatically, hydraulically, electrically, and/or in any other suitable manner.

### CROSS-REFERENCE TO RELATED APPLICATIONS

This application claims the benefit under 35 U.S.C. § 119 (e) of U.S. provisional application Ser. No. 63/315,508, filed Mar. 1, 2022, and U.S. provisional application Ser. No. 63/315,495, filed Mar. 1, 2022, the entire contents of each of which are incorporated by reference in their entirety.

### FIELD

The technology is generally related to fluid mixing systems and related methods. More specifically, methods and apparatuses including containers with internal mixers are disclosed.

### BACKGROUND

Fluid mixers are conventionally used in a variety of applications to agitate fluids in containers. Fluid mixers can allow the fluid agitation process to occur automatically and, in some instances, continuously, which may improve throughput and efficiency when compared to manual mixing processes. In some instances, the mixers can include a motor-driven component (e.g. a propeller) to generate a vortex and mix the fluid. Alternatively, fluid mixers can include a fluid container resting on a rocking platform which moves in a controlled elliptical fashion to agitate the fluid resulting in the desired mixing.

### SUMMARY

In one embodiment, a mixing device includes a container configured to contain a fluid and a mixer disposed in the container. The mixer includes a substrate and a plurality of slots arranged in a pattern on the substrate. Additionally, the plurality of slots define or more spines extending at least partially along an axial direction of the substrate. The mixer also includes a plurality of flaps are configured to move between an extended configuration and a retracted configuration when the substrate is deformed in the axial direction.

In another embodiment, a mixing device includes a container configured to contain a fluid and a mixer disposed in the container. The mixer is configured to induce flow in the fluid contained in the container when the mixer is deformed in an axial direction.

In yet another embodiment, a method of mixing a fluid disposed inside of a container includes displacing opposing end portions of a mixer disposed in the container relative to each other to deform the mixer and induce flow in the fluid.

In some aspects, mixing systems are provided. In some embodiments, a mixing system may include a container configured to contain a fluid, a mixer disposed in the container, and an actuator disposed in the container and operatively coupled to the mixer. The actuator may be configured to axially deform the mixer to induce flow in the fluid contained in the container.

In some aspects, mixing systems are provided. In some embodiments, a mixing system may include a container configured to contain a fluid, a mixer disposed in the container, wherein the mixer is operatively coupled to a first portion of the container, and an actuator disposed in the container. The actuator may be operatively coupled to a second portion of the container and the mixer, and the actuator may be configured to deform the mixer to induce flow in the fluid contained in the container.

In some aspects, methods of mixing a fluid disposed inside of a container are provided. In some embodiments, a method may include axially deforming an actuator disposed in the container to axially deform a mixer disposed in the container, and inducing flow in the fluid disposed in the container when the mixer is axially deformed.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 is a photograph of one embodiment of a mixing system;

FIG. 2A is a photograph of one embodiment of a mixer;

FIG. 2B is a photograph of one embodiment of a mixer;

FIG. 2C is a photograph of one embodiment of a mixer;

FIG. 2D is a photograph of one embodiment of a mixer;

FIG. 3 is a schematic of one embodiment of a mixing system;

FIG. 4A is a schematic of one embodiment of a container with a mixer in the retracted configuration;

FIG. 4B is a schematic of the container from FIG. 4A with the mixer in the extended configuration;

FIG. 5A is a schematic of one embodiment of a container with a mixer in the retracted configuration;

FIG. 5B is a schematic of the container from FIG. 5A with the mixer in the extended configuration;

FIG. 6 is a schematic of another embodiment of a container;

FIG. 7 is a schematic of yet another embodiment of a container;

FIG. 8A is a schematic of one embodiment of a hanging container;

FIG. 8B is a schematic of another embodiment of a hanging container;

FIG. 9 is a schematic isometric view of one embodiment of a container;

FIG. 10 is a graph of mixing times for several exemplary embodiments of a container;

FIGS. 11A-11B are schematics of a mixing system according to some embodiments;

FIGS. 12A-12B are schematics of a mixing system according to one embodiment;

FIGS. 13A-13B are schematics of a pneumatic mixing system according to one embodiment;

FIGS. 14A-14B are schematics of a pneumatic mixing system according to one embodiment;

FIGS. 15A-15D are schematics of a parallel mixing system and actuator according to one embodiment;

FIGS. 16A-16B are schematics of a pneumatic mixing system according to one embodiment;

FIGS. 17A-17C are schematics of a process of operation of an actuator from the pneumatic mixing system of FIGS. 16A-16B;

FIGS. 18A-18C are schematics of a mixing system according to one embodiment;

FIGS. 19A-19B are schematics of a parallel mixing system and actuator according to one embodiment;

FIG. 20 is a schematic of a mixing system according to one embodiment;

FIGS. 21A-21C are schematics of a mixing system according to one embodiment;

FIGS. 22A-22B are schematics of the actuator of the mixing system of FIGS. 21A-21C;

FIGS. 23A-23B are schematics of mixing systems according to two embodiments;

FIGS. 24A-24B are exemplary control systems for a mixing system according to some embodiments;

FIGS. 25A-25B are measurement systems for a mixing system according to some embodiments; and

FIG. 26 is exemplary mixing data for a mixing system.

### DETAILED DESCRIPTION

Existing fluidic handling systems conventionally use structures (such as propellers, as described previously) that are disposed within a fluid and driven to generate vortices in the fluid. In one exemplary system, a magnetic stir bar can be inserted into a container of fluid and placed on a platform that may magnetically rotate the stir bar. The inventors have recognized that this category of fluid mixers may suffer from a lack of parallelization and throughput. In addition, rigid actuators may induce high shear stresses within the fluid, which may inhibit or otherwise damage biological material that may be contained within the fluid.

Alternative existing fluidic systems make use of moving platforms to agitate fluid within a container resting on the moving platform. While this type of system may provide automated and controlled agitation of the fluid, the inventors have recognized that moving platforms (e.g., rocking cell culture platforms) typically require costly equipment with large footprints. These disadvantages may limit the utility of these platforms. In addition, the throughput of these platforms can only be improved by increasing the footprint of the platform. In other words, it may be possible to mix several containers in parallel, but the platform must be suitably large to accommodate the containers simultaneously.

In view of the above, the inventors have recognized benefits associated with fluid mixers which make use of a mixer located inside of a container containing fluid. The mixer may include an elastic substrate, such as a flexible elastic sheet or a sheet that includes portions that are elastic. The substrate may include a plurality of flaps formed therein. In some embodiments, the plurality of flaps may be formed by a plurality of slots arranged in a pattern on the flexible substrate of the mixer such that the plurality of flaps are formed on various portions of the substrate. The flaps may be configured to deflect in a direction that is at least partially normal to a plane that the elastic substrate extends in when the mixer undergoes axial deformation. As the flaps are cyclically moved between a first and second configuration (e.g. the extended and retracted configurations), the flaps may induce flow or otherwise agitate the surrounding fluid (e.g. by generating vortices) within the container. In this way, the fluid within the container (flexible or rigid) may be mixed. In some embodiments, the fluid flow may be generated because of vortex shedding at the edges of the flaps.

In some embodiments, the fluid within the containers described herein (flexible or rigid) may be a liquid such as a liquid solution. In some embodiments, the container may include both a liquid solution and a gas (e.g. nitrogen) or mixture of gases (e.g. air). In some embodiments, the liquid solution within the container may include an additional composition to be mixed with and/or dispersed in the liquid. This additional composition, may include, but is not limited to, pharmaceutical ingredients, bulk drug substances, buffers, cell media, active ingredients, medicament, food products, particles, other liquids, any combination thereof, or any other suitable material, as the present disclosure is not so limited.

The embodiments of mixing systems described herein may provide a relatively smaller footprint as compared to existing mixing systems, and in some instances may facilitate parallel and/or automated operation of the mixing systems. In addition, the disclosed mixing systems may be low-cost and lightweight as compared to existing bulky fluid mixers. It should be appreciated that in some embodiments, the mixing systems may also induce more gentle fluid flow in the fluid within the container (flexible or rigid) when compared to mixers with rigid propellers. Accordingly, lower shear stresses may be applied to the fluid. In embodiments where the fluid contains biological materials such as cells, this reduction in shear stress may improve the viability of the cell cultures.

In some embodiments, the axial deformation of the mixer results in a change in a length of a mixer measured along an axial direction of the mixer parallel to a longitudinal axis of the mixer. For example, the mixer may be situated within the container at a retracted configuration where the mixer may be in a substantially planar configuration. The container may then be deformed along an axis that may be parallel, and in some instances aligned, with the longitudinal axis of the mixer. This may subsequently deform the mixer in the same direction. Accordingly, the mixer may have a length that is substantially equal or greater than a corresponding dimension of the container at the extended configuration, although the mixer (and container) length at the extended configuration may be greater than the mixer (and container) length at the retracted configuration. It should be appreciated that the flaps may be configured to deflect from the mixer at either the retracted or the extended configuration, as the present disclosure is not so limited.

In some embodiments, a mixer may be integrated into a container such that deformation of the container may also deform the mixer. For example, a mixer may be disposed between two opposing layers of one or more flexible films used to form a container. In this exemplary embodiment, the mixer is attached to the container in a manner such that deformation of the container may also deform the mixer and actuate the flaps. In some embodiments, the mixer may be integrated or attached to the container at the seams where two or more opposing portions of film may be bonded to one another to form the flexible container. In such an embodiment, the mixer may be fabricated either using the same or different materials as the films of the container. In some embodiments, the mixer may be attached to the films of the container with high frequency welding, hot plate welding, induction welding, solvent welding, spin welding, laser welding, ultrasonic welding, extrusion-based sealing, hot sealing, cold sealing, adhesives, or any other suitable method, as the present disclosure is not so limited. It should be appreciated that the mixer may be sealed or otherwise integrated into the container in such a way that prevents undesired leakage or other outflow of fluid from the container during use.

In some embodiments, one or more mixers and one or more actuators may be integrated into a flexible container such that deformation of the container may also deform the mixer. For example, a mixer and actuator may be disposed between two opposing layers of one or more flexible films used to form a container. In some embodiments, the mixer and/or actuator may be integrated or attached to the container at the seams where two or more opposing portions of film may be bonded to one another to form the flexible container. In such an embodiment, the mixer may be fabricated either using the same or different materials as the films of the container. In some embodiments, the mixer may be attached to the films of the container with high frequency welding, hot plate welding, induction welding, solvent welding, spin welding, laser welding, ultrasonic welding, extrusion-based sealing, hot sealing, cold sealing, adhesives, or any other suitable method, as the present disclosure is not so limited. It should be appreciated that the mixers and actuators may be sealed or otherwise integrated into the container in such a way that prevents undesired leakage or other outflow of fluid from the container during use.

In some embodiments, the container may be formed of a flexible material, such that it may undergo deformation along with the actuator and mixer assembly. In other embodiments, the container may not undergo deformation with the actuator/mixer assembly. In other words, the mixer may be configured to be deformed by the actuator without a corresponding deformation of the container. This may be beneficial when a rigid container is used. In some such embodiments, the mixer and actuator assembly may be attached at one end portion to a corresponding portion of the container and may be free to move at an opposing end portion of the mixer and actuator assembly. For example, the mixer and actuator assembly may be attached to a removeable lid or base of a rigid container with the other end portion of the mixer and actuator assembly free to move within the internal volume of the container. In another example, a mixer and actuator assembly may be configured to float on a surface of a fluid within the container. In some embodiments, a flexible connection between the mixer/actuator assembly and the container may be used to allow the actuator to suitably deform the mixer without substantially deforming or inducing stress in the container. It should be appreciated that any suitable driving or actuation system may be used for any configuration of the mixing system, including, but not limited to, a system including a flexible container or a system including a rigid container, as the present disclosure is not so limited.

In some embodiments, a container may be configured to be single-use. In other words, the mixer, actuator(s), and/or container may be disposed of after suitable mixing has occurred, though multiuse containers are also contemplated. It should be appreciated that depending on the attachment of the container and the integrated mixer (and/or mixer and actuator assembly), the mixer may be made of similar material to the container (in embodiments where the mixer is fabricated together with the container) or different material from the container (in embodiments where the mixer is assembled to the container). It should also be appreciated that the actuator(s) may be formed of the same or different material from the mixer and/or container.

In some embodiments, the mixers described herein may be configured to move between the previously described retracted and extended configurations upon axial deformation of the associated mixer. For example, the mixers may be connected to actuators capable of displacing opposing portions of the mixers in opposing directions along an axial direction extending along, or parallel to, a longitudinal axis of the mixer. Accordingly, the opposing portions of the mixers may be attached (either removably or permanently) to linkages or other connections associated with the actuators. The actuators may then displace the associated portions of the one or more mixers away from one another (or towards one another), such that the mixers transition between the retracted and closed configurations. It should be appreciated any appropriate type of actuator may be used to controllably displace the opposing portions of the mixers.

It should be appreciated that in some embodiments, a container may be disengaged from the mixer and/or actuator, and a new container may be positioned to be received by the mixer and/or actuator. In this way, the mixer and/or actuator may be reused and integrated robustly into a new mixing system.

In some embodiments, a mixer may be connected to an actuator capable of deforming the mixer along an axial direction extending along, or parallel to, a longitudinal axis of the mixer. Accordingly, the mixers may be coupled to or fixed (either removably or permanently) to linkages or other connections associated with the actuator. The actuators may then deform the associated portions of the mixer such that the mixer transitions between the retracted and closed configurations. In some embodiments, the actuator may be directly welded, sealed, adhered, and/or attached to the mixer. Although several examples of suitable actuators will be described in greater detail below, it should be appreciated any appropriate type of actuator may be used to controllably displace the mixer. Appropriate actuators may include, but are not limited to, actuators including crankshafts, actuators including torsional springs, actuators including ball screws, actuators including cams, pneumatic actuators, piezoelectric actuators, solenoid actuators, hydraulic actuators, and/or any other type of actuator capable of providing the desired deformation, as the present disclosure is not so limited.

These alternative actuation mechanisms may be used in embodiments where the mixer is not deformed by corresponding deformation of the container. In other words, the mixer may be configured to be deformed without a corresponding deformation of the container. This may be beneficial when a rigid container is used. In some such embodiments, the mixer may be attached at one end to a portion of the container and may be free at an opposing end. For example, the mixer may be attached to a removeable lid or base of a rigid container. In another example, a mixer may be floating on a surface of a fluid within the fluid. An external driver, such as the actuation mechanisms described above, may then be used to align the mixer, deform the mixer, deflect the flaps, and mix the fluid without direct physical contact with the mixer. It should be appreciated that any suitable driving or actuation system may be used for any configuration of the mixing system, including, but not limited to, a system including a flexible container or a system including a rigid container, as the present disclosure is not so limited.

The inventors have also recognized benefits associated with fluid mixing systems which make use of a mixer and associated actuator, both located inside of an internal volume of a container configured to contain a fluid, such as a liquid. During operation, the container may also contain one or more compositions in addition to the fluid where it may be desirable to either disperse and/or mix the one or more other compositions with the fluid as elaborated on below. The actuator may axially deform the mixer, which may be formed of an elastic material, to induce out of plane deflection. The elastic mixer may be cyclically moved between its various configurations (e.g., extended and retracted configurations) by the actuator to induce flow or otherwise agitate the surrounding fluid (e.g., by generating vortices) within the container. In this way, the fluid, and any other compositions disposed in the container, may be mixed.

In some embodiments, an actuator may be coupled to a mixer at least at one interface (e.g., at an end portion of the mixer), such that deformation or displacement of the actuator results in deformation of the mixer. In other words, the actuator and mixer may be arranged to allow the mixer to deform together with the actuator, which may deform along at least one axis (e.g., uniaxially deform) though complex actuations including movement in multiple directions are also contemplated. The actuator may be connected to one or more inputs (e.g., hydraulic, pneumatic, electrical) located external to the container, which may serve to drive the actuator between an extended and retracted configuration. Positioning the actuator internal to the container may reduce the overall footprint of the mixing system, allowing for greater parallelization and throughput of mixing systems.

The mixing systems of the present disclosure may employ any suitable actuator or combination of actuators, as will be described in greater detail below. In some embodiments, the actuators may be hydraulically and/or pneumatically driven, such that an inflow/outflow of fluid (e.g., air, gas, water) may deform the actuators in at least one axial direction, which may in turn deform the mixer, inducing flow within the container. In some embodiments, the actuators may be electrically driven, such that an applied electrical potential and/or current may deform the actuators in at least one axial direction to deform the mixer. Of course, embodiments in which the actuator(s) are driven by a combination of hydraulic, pneumatic, electrical, and/or any other suitable input are also contemplated, as the present disclosure is not so limited. In some embodiments, a readily available compressed air source may serve as the input source.

In some embodiments, an actuator and mixer may be arranged in series, such that axial deformation of the actuator may result in an opposing axial deformation of the mixer. For example, contraction of the actuator may result in extension of the mixer and expansion of the actuator may result in compression of the mixer. For example, the actuator may be coupled or fixed to the mixer at one end and to the container (which may be rigid or flexible) at an opposing end portion. The mixer may similarly be coupled or fixed to the container at its opposing end portion. In this way, the mixer may be deformed in the opposite direction of the actuator to induce fluid flow in the container.

In some embodiments, the actuator and mixer may be arranged in parallel, such that they may deform in a similar direction along the same axis. For example, the actuator and mixer may be coupled or fixed to one another at correspond end portions of each component, such that axial deformation of the actuator may result in a corresponding axial deformation of the mixer. In other words, a portion of the mixer disposed between opposing end portions of the actuator may undergo the same deformation (both in direction and magnitude) as the actuator. As described previously, the mixer may include one or more features which may deflect or otherwise move due to the axial deformation of the mixer to induce flow in the container.

In some embodiments, the mixer may include an elastic substrate, such as a flexible elastic sheet or a sheet that includes portions that are elastic. The substrate may include a plurality of flaps formed therein in some embodiments. In some embodiments, the plurality of flaps may be formed by a plurality of slots arranged in a pattern on the flexible substrate of the mixer such that the plurality of flaps is formed on various portions of the substrate. The flaps may be configured to deflect in a direction that is at least partially normal to a plane that the elastic substrate extends in when the actuator axially deforms the substrate. Accordingly, the flaps may induce flow or otherwise agitate the surrounding fluid within the container. In some embodiments, the fluid flow may be generated because of vortex shedding at the edges of the flaps.

In some embodiments, the mixers described herein may be formed by elastic sheets that may be deformed to transition the mixers between the above noted retracted and extended configurations. The mixers may include a combination of spines, hinges, and slots formed in the elastic sheet to provide the desired functionality in some embodiments. For example, the slots, hinges, and/or spines may be formed in a pattern. In one such embodiment, the pattern may include a lattice of slots which may form the hinges and one or more spines of the mixers where the hinges may be living hinges corresponding to small regions of material between adjacent sections of the patterned elastic sheet. The type of movements exhibited by a given mixer may depend on the pattern and positioning of the slots formed in the mixers. In other words, different modes of deformation may be achieved with different designs and arrangements of the slots. In some embodiments, the combination of slots, hinges, and spines of the mixers may be in a Kirigami formation. In such an embodiment, a mixer may deform between the retracted and extended configurations in an elastic fashion when two or more opposing portions of the mixer are subjected to an axial deformation. In other words, portions of the mixers, such as the flaps, may deflect in a direction normal (or otherwise different from) a direction of deformation applied to the mixer, which in some embodiments may be oriented along a longitudinal axis of the mixer. In some embodiments, the cyclic deformation of the one or more mixers between the extended and retracted configurations, may cyclically extend and retract the one or more flaps formed in the mixer. It should be appreciated that in some embodiments, the pattern of the mixer may be configured to allow flap deflection from the mixer when the container is deformed along an axis that is not substantially co-axial with a longitudinal axis of the mixer as well as flap deflection in directions that are not aligned with the longitudinal axis of the mixer.

The one or more spines of a mixer may span across at least a portion of an axial length of a mixer. In some embodiments, the spines may span directly across at least a portion of the substrate forming a mixer along the axial length of the mixer, while in other embodiments, the one or more spines may follow a tortuous path across at least a portion of the substrate along the axial length of the mixer. In some embodiments, the spines, flaps, and slots may be formed in a single monolithic substrate. In other embodiments, the various components of the mixer may be joined to form an integrated substrate.

It should be understood that the spines and slots formed in a substrate, such as an elastic sheet, corresponding to a mixer may have any appropriate configuration for a desired application. In some embodiments, the slots may be formed during fabrication of the mixers such that the slots may be portions of the mixer without any material. In other words, the slots may be gaps or openings in the mixer structure that enable the specific deformation of the mixer. In other embodiments, the slots may be cut or otherwise removed from the substrate of a mixer after fabrication. For example, the slots may include a pattern of cuts and/or openings formed in the substrate. It should be appreciated that the various features of the mixers may be formed using laser cutting, stamping, etching, any combination thereof, or any other suitable technique as the present disclosure is not so limited.

In some embodiments, the flaps of the mixers may be configured to deflect out of a plane of the mixer when the mixer undergoes axial deformation. Accordingly, the flaps may be sufficiently elastic to deflect from the substrate and agitate nearby fluid within the container. It should be appreciated that the flaps may move linearly or non-linearly out of plane from the substrate upon axial deformation, or in any other suitable manner, as the present disclosure is not so limited.

It should also be appreciated that the mixing of fluid by flaps deployed out of a substrate of a mixer may be determined by a variety of factors, including but not limited to, the number of flaps on the substrate, the arrangement of flaps on the substrate, the shape of the flaps, the frequency of actuation, the amplitude of actuation, the mechanical properties of the flaps (e.g. elastic modulus), the geometric properties of the flaps (e.g. thickness, length, width, and/or surface area of the flaps), the properties of the fluid (e.g. viscosity), any combination thereof, or any other suitable factors. It should be appreciated that any combination of the aforementioned factors may be adjusted or otherwise modified to achieve a desired degree of fluid mixing by the mixing systems disclosed herein.

While in a majority of the embodiments disclosed herein the flaps of a mixer may be deployed out of plane when the mixer is deformed, in other embodiments, the flaps of the mixers may be configured to deflect toward the plane of the mixer when the mixer undergoes axial deformation. In these embodiments, the flaps may be co-planar with the plane of the substrate in the mixer's extended configuration and deflected out of plane of the substrate in the mixer's retracted configuration. Further, embodiments in which the flaps are not co-planar with the substrate in either the extended or retracted configuration are also contemplated. For example, the flaps may move between a first position angled from the substrate to a second position, also angled from the substrate, between the extended and retracted configuration. In some embodiments, the flaps may move between one side of the plane and another side of the plane between the extended and retracted configuration of the mixer.

It should be appreciated that some mixers may include a combination of different flap configurations. For example, a mixer may include one set of flaps that deflect from one side of the substrate in the extended configuration as well as a second set of flaps that deflect from the opposite side of the substrate in the extended configuration. This flap arrangement may induce greater fluid flow when compared to a mixer with flaps deflecting in only one direction away from the plane of the substrate. It should be appreciated that any suitable arrangement of flaps may be used, as the present disclosure is not so limited.

In some embodiments of the mixing system, the container may be placed on a suitable support structure. In this way, the container may be supported by the support structure prior to its engagement with the actuators. In some embodiments, this support structure may be automated such that a series of containers may be sequentially moved to a position in which the actuators may be engaged with the container, akin to a conveyor belt. In other embodiments, the container may only be supported by the actuators, in which case the connections to the actuator may function as the support. For example, the container may be suspended between two actuators or between an actuator and a stationary structure. These embodiments may reduce the overall footprint for the mixing system, as the system may not need a platform or support on which the container may rest.

In embodiments where the flexible container is suspended, the container may be hung from a support that is configured to suspend the container at least partially from the support on at least one side. This configuration may reduce the footprint of the mixing system and may enable multiple containers to be mixed in parallel in a smaller footprint of space. Accordingly, the flexible container may be hung from a support which may include a clamp, hook, or other attachment arrangement to effectively hold the flexible container and prevent accidental release of the flexible container, which may contaminate or otherwise damage the container. For example, in some embodiments, the container may be connected to the support using a hook inserted into an eyelet on the container, a clamping arrangement may be used, and/or any other appropriate connection method may be used as the disclosure is not so limited. It should be appreciated that the flexible container may be hung in any suitable arrangement as the present disclosure is not so limited. Depending on the embodiment, the support may be part of a reusable mixing system where the support is configured such that separate containers may be sequentially attached to and removed from the mixing system.

In some embodiments, a mixer may extend completely across a portion of a container. In other words, the mixer may extend from a first side to a second opposing side of the container. It should be appreciated that the mixer may extend at any suitable angle from the edge (e.g. perpendicular, diagonally from the edge at 45°, or any other appropriate orientation), as the present disclosure is not so limited. In other embodiments, the mixer may be curved or otherwise nonlinear and/or may simply be associated with a different portion of the container. For example, in some embodiments, a mixer may extend from a first side to a second adjacent side of the container. Thus, it should be understood the current disclosure is not limited to the arrangement of a mixer within a container.

In some embodiments, a mixer and actuator assembly may extend across a portion of a container. In other words, the mixer and actuator assembly (in the parallel, series, and/or any other suitable arrangement) may extend from a first side to a second opposing side of the container. It should be appreciated that the mixer and actuator assembly may extend at any suitable angle from a side of the container (e.g., perpendicular, diagonally from the edge at 45°, or any other appropriate orientation), as the present disclosure is not so limited. Thus, it should be understood the current disclosure is not limited to the arrangement of the mixer and actuator assembly within a container.

In embodiments where the mixer extends from at least one side to an opposing side of a flexible container, it may be desirable for the mixer to have a length that is less than a corresponding dimension of the film extending between the sides of the container. This may permit the flexible container to be filled with a fluid volume while still permitting the flexible container and mixer to be deformed in the desired direction. In such an embodiment, an axial length of the mixer (either in the extended or retracted configuration) may be at least 5%, 10%, 15%, 20%, 25%, 30%, 35%, 40%, 45%, 50%, 55%, 60%, 70%, 75%, 80%, 85%, 90% or any other suitable percentage of a length taken along an external surface of the container between the two opposing sides of the container (e.g. the distance measured between the two opposing surfaces as measured along the exterior surface of a film extending between the two sides). Correspondingly, the axial length of the mixer may be less than or equal to 95%, 90%, 85%, 80%, 75%, 70%, 60%, 55%, 50%, 45%, 40%, 35%, 30%, 25%, 20%, and/or any other appropriate percentage of the length of the container taken along the external surface of the cane container between two opposing sides. Combinations of the foregoing ranges are contemplated including, for example, an axial length of the mixer that is between or equal to 5% and 95% of a length taken along an external portion of the container extending between the opposing sides of the container. However, it should be appreciated that the mixer may be any length in relation to the container, as the present disclosure is not so limited.

In some embodiments, a container may include multiple mixer and actuator assemblies distributed within the interior volume of the container. For example, there may be two or more assemblies distributed along a side of the container and extending to an opposing side, or other portion, of the container. Depending on the embodiment, the assemblies may either be distributed evenly or unevenly along a side of the container. In some embodiments, there may be at least one, two, three, four, five, six, seven, eight, nine, ten, or any other suitable number of assemblies along an edge of the container, as the present disclosure is not so limited. It should be appreciated that each assembly may have a different arrangement and actuator (e.g., hydraulic, pneumatic, electric) type.

As described previously, in some embodiments, the mixer may only be attached to one portion of the container (e.g. when the container is rigid). In these embodiments, the mixer length (either in the extended or retracted configuration) may be at least 5%, 10%, 15%, 20%, 25%, 30%, 35%, 40%, 45%, 50%, 55%, 60%, 70%, 75%, 80%, 85%, 90%, 95%, or any other suitable percentage of a corresponding dimension of the container that the mixer extends in. The mixer may also have a length that is less than or equal to 99%, 90%, 80%, 70%, 60%, 50%, and/or any other suitable percentage of the corresponding dimension of the container. Combinations of these ranges are contemplated including, for example, a mixer with a length that is between 5% and 100% of a corresponding dimension of the container where the mixer extends in direction parallel to the noted dimension. In some embodiments, the mixer length may be substantially equal to a corresponding dimension of the container that the mixer extends in. Accordingly, it should be understood that a mixer may have any suitable size (i.e. length and/or width) in relation to the container, as the present disclosure is not so limited.

It should also be appreciated that a mixer may be deformed by any appropriate deformation magnitude capable of being used with the associated container and volume of fluid contained therein. The overall deformations that may be applied may be influenced by parameters such as the fluid volume, the elasticity of the container material, the external surface area of the container, an external perimeter of the container taken in a plane parallel to a longitudinal axis of the one or more mixers of a system, and/or any other appropriate parameter. Accordingly, it should be appreciated that a mixer may undergo any suitable change in its length between the extended and retracted configurations for a given application, as the present disclosure is not so limited.

In some embodiments, a container may include multiple mixers distributed within the interior volume of the container. For example, there may be two or mixers that are distributed along a side of the container and extend to an opposing side, or other portion, of the container. Depending on the embodiment, the mixers may either be distributed evenly or unevenly along a side of the container. In some embodiments, there may be at least one, two, three, four, five, six, seven, eight, nine, ten, or any other suitable number of mixers along an edge of the container, as the present disclosure is not so limited. It should be appreciated that the multiple mixers may also either have the same or different mixer lengths.

In embodiments where the container includes more than one mixer, the mixers may be controlled cyclically. For example, the container may include three mixers configured to be deformed in a sequential manner. In this embodiment, the sequence of mixers may follow a wave pattern across the container and subsequently induces sequential flow in different regions of the interior volume of the container. In instances where different mixers are actuated at different times, it should be appreciated that in such embodiments, the container may be sufficiently flexible to allow localized deformation of a flexible container and/or the different mixers may be capable of being actuated separately for a rigid container. It should be appreciated that the mixer(s) may be controlled in any suitable manner, for example synchronously or asynchronously, as the present disclosure is not so limited. In embodiments where the container includes more than one mixer, the mixers may be controlled with different actuators. Alternatively, the mixers may be controlled with the same one or more actuators, configured to alternatively deform the mixers. It should be appreciated that any suitable configuration between the actuators and the mixers may be used as the present disclosure is not so limited.

In embodiments where the container includes more than one mixer and actuator assembly, the assemblies may be controlled cyclically. For example, the container may include three assemblies configured to be deformed in a sequential manner. In this embodiment, the sequence of assemblies may follow a wave pattern across the container and subsequently induce sequential flow in different regions of the interior volume of the container. However, simultaneous actuation of the different mixers may also be used as the disclosure is not so limited.

In some embodiments, a mixing system may include at least one processor to control the actuators responsible for deforming the mixers. The processor(s) may be responsible for operating the actuators, which in turn may deform the mixers. In some embodiments, all actuators may be controlled with a single processor, and in other embodiments, separate processors may be used to control separate actuators. It should be appreciated that the processor(s) may control the actuators with any suitable mode of communication, including but not limited to, a wired communication link or a wireless communication link, as the present disclosure is not so limited. In some embodiments, the processor(s) may be configured to operate the mixing system automatically and/or continuously.

In some embodiments, a mixing system may include at least one processor to control the actuators responsible for deforming the mixers. The processor(s) may be responsible for operating the actuators, which in turn may deform the mixers. In some embodiments, the processor(s) may be in communication with one or more controller(s) which may serve to operate the actuators. For example, the controller(s) may be in communication with a fluid source connected to one or more pneumatic actuators. The controller(s) may control the frequency, magnitude, duration, and/or any other parameter of the actuation cycles. It should be appreciated that any suitable arrangement, type, and/or number of processors and controllers may be employed in the mixing systems described here, as the present disclosure is not so limited.

In some embodiments, the actuator(s) may be configured to operate at a suitable frequency to induce a desired amount of flow within the container without excessive agitation. For example, in one embodiment, the actuators may induce the mixer to cycle from the retracted configuration to the extended configuration and then back to the retracted configuration with a frequency of 1.5 Hz. However, it should be appreciated that the actuation frequency may be any appropriate frequency including frequencies that are greater than or equal to 0.01 Hz, 0.02 Hz, 0.05 Hz, 0.1 Hz, 0.5 Hz, 1 Hz, 5 Hz, 10 Hz, 20 Hz, 30 Hz, 40 Hz, 50 Hz, 60 Hz, and/or any other appropriate frequency. The actuation frequency may also be less than or equal to 100 Hz, 90 Hz, 80 Hz, 70 Hz, 60 Hz, 50 Hz, 40 Hz, 30 Hz, 20 Hz, 10 Hz, and/or any other appropriate frequency. Combinations of the foregoing ranges are contemplated including an operation frequency that is between or equal to 0.01 Hz and 100 Hz. However, frequency ranges both greater than and less than those noted above are also contemplated as the present disclosure is not so limited. It should be appreciated that the actuation frequency may be dependent upon the limiting factors of the actuation system.

In some embodiments, the actuation of the mixers may further include an actuation amplitude. The actuation amplitude may correspond to the degree of deformation of the flaps relative to the associated substrate. In some embodiments, a maximum actuation amplitude may be equal to the movement of the flaps between a fully retracted and fully extended configuration of the flaps. However, amplitudes for an individual actuation cycle that are less than this full operation range may also be applied. For example, in some embodiments, the actuation amplitude may be at least 5%, 10%, 15%, 20%, 25%, 30%, 35%, 40%, 45%, 50%, 55%, 60%, 70%, 75%, 80%, 85%, 90%, 95%, 100% or any other suitable percentage of the fully operational range of the mixer as the present disclosure is not so limited. Additionally, combinations of the above-noted ranges where the amplitude of an actuation cycle is between or equal to any of the above-noted ranges are also contemplated.

In some embodiments, a mixing system may be configured to operate at a given actuation frequency for any number of cycles to suitably mix or otherwise incubate the contents of a container, wherein a cycle may include movement of the mixer between the extended and retracted configurations due to the actuator(s). In some embodiments, the mixing system may operate for at least 2, 3, 4, 5, 6, 7, 8, 9, 10, 12, 15, 18, 20, 25, 30, 35, 40, 45, 50, or 100 cycles. The number of cycles applied by a system during mixing of a container may also be less than or equal to 1000 cycles, 500 cycles, 100 cycles, 50 cycles, and/or any other appropriate number as the disclosure is not so limited. Combinations of the foregoing ranges are contemplated including, for example, a mixing system that operates one or more mixers of the system to apply between or equal to 2 mixing cycles and 1000 mixing cycles though ranges both greater than and less than those noted above are also contemplated. In some embodiments, dependent on the actuation frequency of the mixers, the mixing system may operate for any suitable period of time, including, but not limited to 2 sec, 15 sec, 30 sec, 1 min, 5 min, 30 min, 1 hr, 2 hrs, 3 hrs, 5 hrs, 10 hrs, 12 hrs, 24 hrs, 2 days, 5 days, 10 days, or any other suitable period of time. Correspondingly, the mixing system may be operated for less than 300 days, 200 days, 100 days, 50 days, 10 days, 1 day, and/or any other appropriate duration when mixing the contents of a given container. Combinations of the above-noted ranges are contemplated including, for example, a mixing duration that is between or equal to 2 seconds and 300 days may be used. Accordingly, it should be understood that a mixer and container may be configured to operate using any suitable duration and/or frequency to provide a desired amount of mixing over a given mixing duration.

It should be appreciated that the mixers and/or actuators, which may be positioned internal to the container, may be formed of any suitable material compatible with the fluid contained in the container. In some embodiments, the material of the mixers and/or actuators may be more rigid than the material of the container. In some embodiments, the mixers and/or actuators may include a multilayer composition. In other embodiments, the mixers and/or actuators may include one or more composite materials to facilitate fabrication and longevity. In other embodiments still, the mixers and/or actuators may include thermoplastics, elastomers, composites, metals, any combination thereof, or any other suitable material, as the present disclosure is not so limited. Accordingly, it should be appreciated that in the mixers and/or actuators may be made from any suitable material, or combination of materials, which exhibit sufficient strength and elasticity to perform the desired functions described herein.

In some embodiments, the actuators, which may also be positioned internal to the container, may have a coating or outer layer formed of any suitable material compatible with the fluid contained in the container, despite any materials which may be located internal to the actuator, arranged to actuate the mixer. In other words, the actuators may be formed of any suitable material or combination of materials suitable for actuation, but may also include a coating or outer layer to reduce the risk of contamination. Contamination may occur with fluid flowing from the internal volume of the container into the actuator and/or actuation fluid flowing from the actuator to the internal volume of the container. Accordingly, the coating or outer layer of the actuators may seal the actuator relative to the surrounding internal volume of the container to substantially prevent the flow of fluid into and out of the actuator. In some embodiments, the coating or outer layer of the actuators may be deposited on the actuators with any suitable technique, including, but not limited to, welding, spraying, adhering, mechanically bonding, combinations thereof, and/or any other suitable technique.

In some embodiments, the container, outer coating of the actuator, and/or mixer may be sufficiently flexible and deformable to mix the contents contained within an interior of the container. Accordingly, the container, outer coating of the actuator, and/or mixer may be made of a single-layer or multilayer film. In some embodiments, the container, outer coating of the actuator, and/or mixer may be composed of one or more layers of polymers including, but not limited to, polypropylene, polyethylene, ethylene vinyl alcohol, polyamide, polychlorotrifluoroethylene, cyclic olefin copolymer, polycarbonate, ethylene vinyl acetate, polyvinyl chloride, polyvinylidene chloride, polystyrene, polyethylene terephthalate, thermoplastic elastomer, polymethyl methacrylate, polysulfone, polyesters, polyolefins, epoxies, phenolics, novolacs, thermosets, thermoplastics, composites, any combination thereof, or any other suitable polymer or flexible material as the present disclosure is not so limited. The container, outer coating of the actuator, and/or mixer may also be made of material capable of withstanding temperatures below 0° C., for example −20° C., and/or temperatures above 30° C., for example 37° C. As noted previously, in some embodiments, the container may be rigid, such that it may be formed of any suitable rigid material including ceramics, metals, polymers, combinations thereof, and/or any other material.

It should be appreciated that the container, outer coating of the actuator, and/or mixers disclosed herein may be made of any suitable material that is compatible with the composition of the fluid (e.g., biocompatible for bioreactor applications), as the present disclosure is not so limited. The material may also withstand sterilization (e.g., withstand gamma irradiation, autoclave sterilization, and/or any other appropriate sterilization procedure) for biological or other contamination sensitive applications.

As described previously, the mixer may be made of the same material as the container. However, in other embodiments, the mixer may be made of different material than the container. It should be appreciated that the mixer may also be made of any suitable material that is both compatible with the contents of the fluid (e.g. biocompatible for bioreactor applications) and sufficiently flexible to enable deflection of the flaps, as the present disclosure is not so limited. The mixer may also be made of material that may be suitably sterilized (e.g. withstand gamma irradiation procedures) for biological applications. The mixer may also be made of material capable of withstanding hot and cold conditions.

In some embodiments, surfaces of the container, outer coating of the actuator, and/or mixer that are configured to be in contact with the fluid during operation may include a layer to reduce fouling (i.e., the layer may be anti-biofouling). In this way, the mixing system may be used for a prolonged period of time. Accordingly, the mixing system may include a layer of an anti-fouling material disposed on one or more surfaces that are exposed to the fluid. Appropriate types of anti-fouling layers may include, but are not limited to low density polyethylene, very low-density polyethylene ethylene vinyl acetate copolymer, polyester, polyamide, polyvinylchloride, polypropylene, polyfluoroethylene, polyvinylidenefluoride, polyurethane or fluoroethylenepropylene, any combination thereof, or any other suitable material that may reduce fouling, as the present disclosure is not so limited. In some embodiments, a gas and/or water vapor barrier layer may be disposed on one or more surfaces of the mixing system where the barrier layer may include materials such as an ethylene/vinyl alcohol copolymer mixture within a polyamide or an ethylene vinyl acetate copolymer.

It should also be appreciated that the mixing systems described herein may be used with containers of any suitable size. For example, a container may have a volume of at least 1 mL, 2 mL, 10 mL, 20 mL, 50 mL, 100 mL, 200 mL, 500 mL, 1 L, 2 L, 10 L, 50 L, 100 L, 500 L, or any other suitable volume. The container may also have a volume that is less than or equal to 1000 L, 500 L, 100 L, 50 L, 10 L, 1 L, and/or any other appropriate volume. Combinations of the foregoing are contemplated including, for example, a container may have a volume that is between or equal to 1 mL and 1000 L. However, volumes both greater than and less than those noted above are also contemplated as the mixing systems described herein are not limited by the size or scale of the container.

It should be appreciated that the mixing system described herein may be used for any suitable application, including, but not limited to, mixing fluid solutions (including, for example, buffer solutions, cell culture media), homogenizing solutions, such as homogenizing previously frozen samples (which may, for example, include active or pharmaceutic agents), and cell culture applications, such as cell growth or proliferation of suitable cells, including, but not limited to, CHO cells, HEK cells, T cells, stem cells, iPSC cells, combinations thereof, and/or any other suitable type of cell. In some embodiments, the mixing system may be used to uniformly and rapidly dethaw a frozen solution or a frozen product. In other embodiments, the mixing system may be used in intravenous fluid delivery applications, where a container of fluid (which may include cells) may be delivered to a patient during a therapeutic window. In other embodiments, the mixing system may be used in a bioreactor. In other embodiments still, the mixing system may be used in conjunction with cell culture platforms. In other embodiments still, the mixing system may be used to homogenize or otherwise mix buffers and ingredients contained within the container (flexible or rigid). It should be appreciated that the mixing system may be used for any suitable application, as the present disclosure is not so limited.

In some embodiments, single-use containers with integrated mixers and/or actuators may be low-cost and apply less shear stress to the contents of the container, which may reduce the risk of damage to the contents (e.g., primary T cells or iPSC cells) while enhancing mixing efficiency.

In some embodiments, pneumatically actuated mixers and/or actuators may be perforated to server as a sparging system to couple mixing with the introduction of a fluid (e.g., oxygen). In such an embodiment, pores formed in the actuators may be fluidly coupled to the pneumatic volume within the actuator such that when pressurized gas is introduced into the pneumatic actuator, the gas may also flow through the pores and into the surrounding fluid.

While the currently disclosed mixers have been disclosed as being integrated with flexible containers and/or new containers, in some embodiments, it may be desirable to include such functionality in existing equipment. Accordingly, in some embodiments, pneumatically actuated mixers and/or actuators may be integrated into existing cell culture vessels to minimize the shear stress applied to cells while still achieving suitable mixing efficiencies.

In some embodiments, the mixing systems of the present disclosure may be used to keep cells in suspension in therapy infusion bags. Specifically, the mixing systems may be integrated with bags containing cell therapeutics (e.g., T cells, stem cells), which may be delivered to a patient through intravascular infusion (and/or any other suitable mode of delivery to a patient). Infusion processes typically span from minutes to hours, during which cells may sediment or otherwise aggregate due to gravitational forces, resulting in non-uniform dosage delivery. The mixing systems described herein may be used to ensure cells remain homogenously distributed in the bag during delivery for proper treatment and uniform dosage delivery.

In the various embodiments described herein, a bioreactor may include a compartment configured to contain live organisms or cells that produce biological compounds. These cells or organisms may either be suspended in liquid disposed inside the reactor and/or may be attached to solid particles and/or surfaces disposed inside of the reactor. The environment within the bioreactor may be monitored and maintained for healthy growth of cells. Temperature, pH, dissolved oxygen, and gas flow rates are examples of potential process parameters that may be controlled to permit the cell or organism growth to be healthy, repeatable and reliable.

In some embodiments, the cells, organisms, and/or the particles cells are attached to may be suspended in a liquid contained within a bioreactor to permit the whole, or other desired portion, of the volume in the bioreactor to be used and to enable the production of a high cell density culture. To keep the cells, organisms, and/or microparticles in suspension, the bioreactor media may be stirred, shaken, and/or mixed using the systems and methods as described herein. The mixing rate may affect the mixing ratio, dissolution of oxygen in the media, and the flow profile leading to shear stress to the biological organisms. Hence, the mixing rate may be optimized and controlled for a given mixture. Some cells such as stem cells or T cells are very sensitive to shear stress, and the mixing rate may need to be appropriately controlled to not damage the cells. As noted previously, the described systems and methods may advantageously provide low shear rate mixing which may help enhance the viability of cell cultures.

It should be appreciated that while mechanical actuators are primarily described for actuation of the mixers described herein, any suitable mechanisms capable of applying a deformation to the mixers to induce movement between the retracted and extended configurations may be used as the disclosure is not so limited. For example, electromagnetic actuation, pneumatic actuation, light-responsive actuation, and/or any other appropriate type of actuation method may be used as the present disclosure is not so limited. Accordingly, the mixers may be made of magnetic materials (e.g. polymers with embedded magnetic particles), light-responsive materials, gas-filled channels (for pneumatic actuation), dielectric elastomers, electroactive responsive materials, and/or any other appropriate material depending on the type of actuation applied to the mixers.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

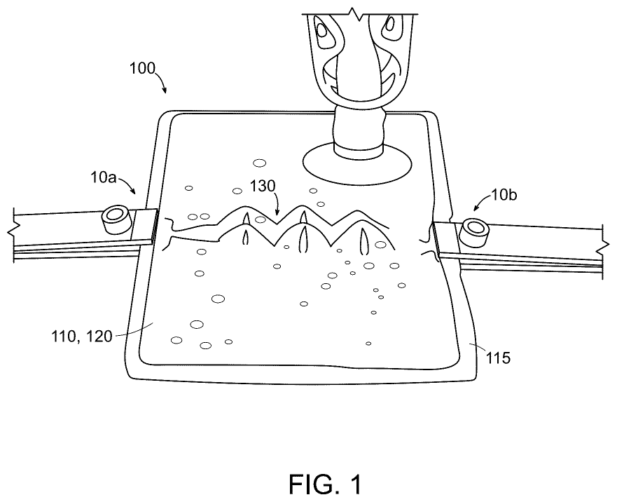

FIG. 1 shows one embodiment of a mixing system with a container 100 formed from two flexible films 110 and 120 that are bonded at least partially around a perimeter of the container to form an internal volume therebetween. The system includes a mixer 130 that is disposed between the flexible sheets 110, 120 such that it extends from a first side to a second opposing side of the container. In the depicted embodiment, the two end portions of the mixer are sealed between two opposing portions of the flexible films at the seam 115 of the container 100 corresponding to the bonded periphery of the films. During operation, the container 100 may be positioned proximate to one or more actuators 10a and 10b that are engaged with the end portions of the mixer. During operation the one or more actuators may deform the container 100 and mixer 130 along an axis extending between the actuators, or between an actuator and a stationary support associated with the other opposing portion of the mixer. As the container 100 is deformed along the deformation axis of the actuators 10a, 10b, the mixer 130 may also be deformed along an axis that is parallel to the axis extending between the two actuators, which in this case is parallel to the longitudinal axis of the mixer. As elaborated on below, this may result in the mixer being actuated to move between a first and second configuration (e.g. an extended and retracted configuration) to agitate or otherwise induce flow within the fluid of the container 100.

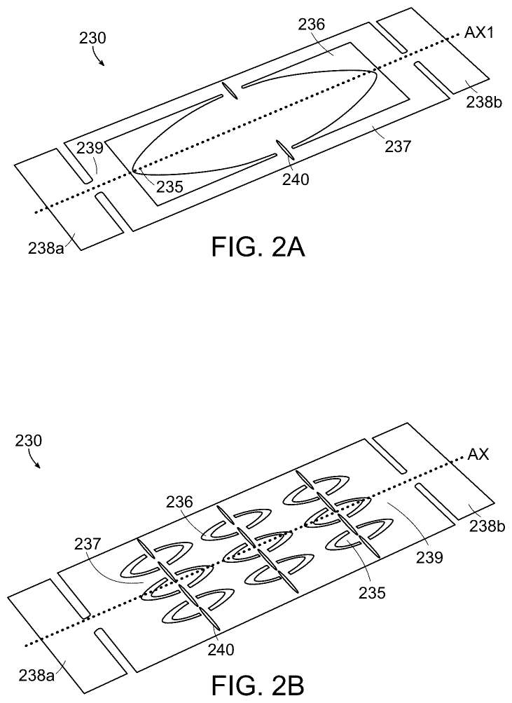

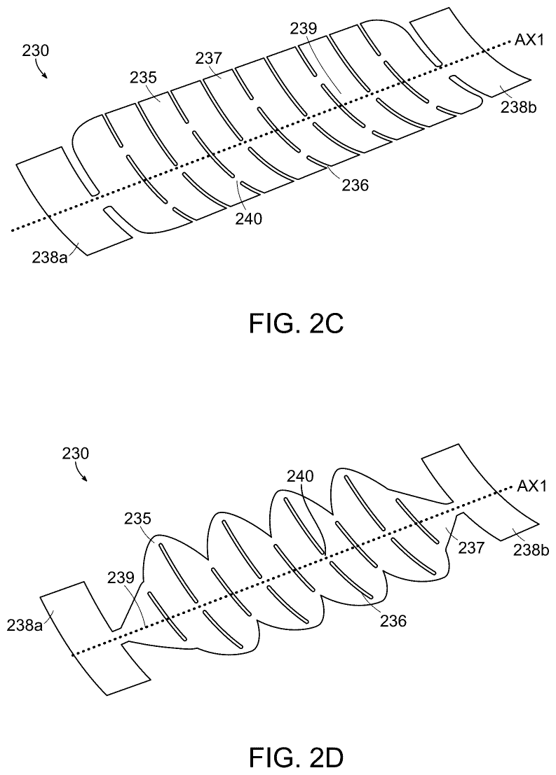

FIGS. 2A-2D depict various embodiments of a mixer. The mixers 230 include a substrate 237. As described previously, the mixers may include various features such as slots, flaps, and spines arranged on the substrate. As shown in the figures, the substrate 237 generally defines the surface on which the mixer features may be arranged. A substantially planar substrate 237 in the retracted configuration is illustrated in the depicted embodiments. Such It should be appreciated that while the depicted substrates are substantially planar in the retracted configuration in, the substrate may not be planar in the retracted configuration in other embodiments.

In the depicted embodiments of FIGS. 2A-2D the mixer 230 may include two opposing end portions by two opposing tabs 238a and 238b which may be configured to be sealed in, or extend past, the seam 115 of the container 100, see FIG. 1. Although rectangular tabs are shown in the figures, the tabs may have any suitable geometry or arrangement to allow sufficient attachment to the container 100 for indirect deformation of the mixer due to deformation of the container and/or for being engaged by an actuator or other support during operation.

The depicted mixers 230 may further include a plurality of slots 236 formed in the substrate 237 which may be configured to allow the mixer to deform. Specifically, the slots 236 may be an area of the substrate 237 which has no material, or in other instances, the slots may be thin cuts in the substrate. In either case, the pattern of the slots may also define a plurality of living hinges 240 distributed on the substrate, where a living hinge corresponds to an region of the substrate with a localized reduced area that may undergo localized deformation that is greater than an average deformation of the substrate when the mixer is deformed to enable the desired transitions between different configurations during operation, It should be appreciated that the slots may be any opening or cut within the substrate to allow elastic deflection of the flaps, as the present disclosure is not so limited.

The depicted mixers 230 may also include one or more spines 239 corresponding to continuous strips of material that extend from one end portion of the mixer to an opposing end portion of the mixer. Thus, the spines may span across at least a portion of the axial dimension AX1 of the mixer 230. In some embodiments, the spines 239 may follow a tortuous path between the tabs of the mixer 230 as shown in FIGS. 2A-2D.

The mixer 230 may further include a plurality of flaps 235 formed in the substrate. Depending on the embodiment, the flaps may correspond to shapes cut out of a substrate of the mixer, see FIGS. 2A-2B, or the flaps may simply correspond to an outer edge of the mixer, see the flat edges in FIG. 2C and the finger like curved edges in FIG. 2D. In either case, the flaps 235 may be configured to deflect at least partially out of the plane of the substrate 237 upon axial deformation, as described previously. This may be due to localized deformation of the living hinges 240 defined by the pattern of slots 236 causing the living hinges to create an out of plane moment that deforms the fins in the desired direction when the mixers are deformed. In view of the various configurations of a mixer, it should be appreciated that the flaps, slots, and other components of a mixer may be located at any suitable position and may have any suitable configuration on a substrate, as the present disclosure is not so limited.

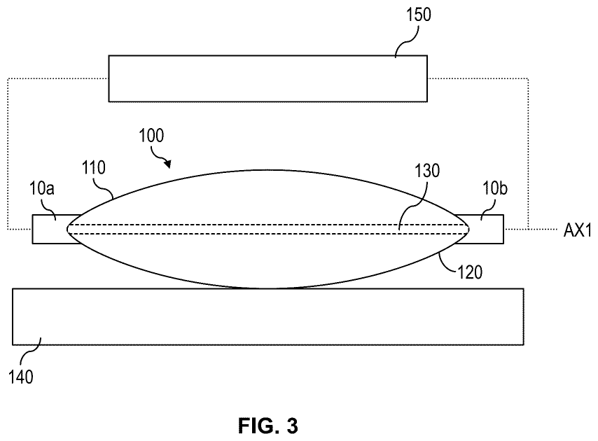

FIG. 3 is a front view of a mixing system. The mixing system may include a container 100 with a plurality of films 110, 120 bonded along the perimeter to form an internal volume as noted above. In the depicted embodiment, the container 100 is a flexible container. In some embodiments, the mixer 130 may be disposed between the films 110, 120 of the container 100. As described previously, the mixer 130 may be attached to the container 100 at the seams 115 as shown in FIG. 1. The container may also be engaged with actuators 10a, 10b which may be aligned with a longitudinal axis AX1 of the mixer in some embodiments. It should be appreciated that while two actuators 10a, 10b are shown in FIG. 3, any number of actuators may be used, as the present disclosure is not so limited. The container 100 may also be disposed on a support 140, such that the container may be supported on the underlying surface of the support either prior to and/or when engaged from the actuators 10a, 10b. In other embodiments, the container 100 may be suspended between the actuators 10a, 10b where either the actuators or another structure function as the support 140. Such an arrangement may be beneficial in order to reduce the overall footprint of the mixing system. As described previously, the actuators 10a, 10b may be operatively coupled with and controlled by processor(s) and/or controller(s) 150. However, embodiments in which an analog system without a processor is used are also contemplated.

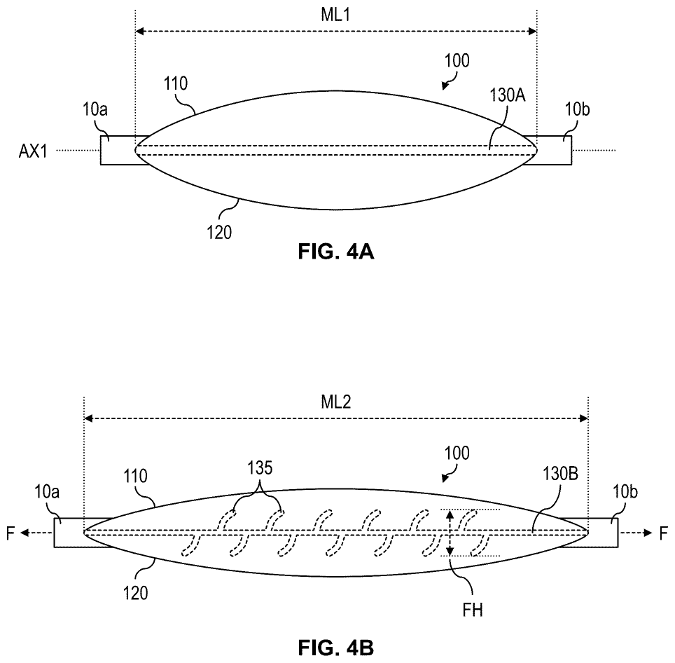

FIGS. 4A and 4B depict one exemplary embodiment of a container undergoing an actuation cycle. The mixer of FIG. 4A is in the retracted configuration 130A, such that the mixer is not experiencing axial deformation along its axial dimension AX1 from the actuators 10a, 10b and is in the initial undeformed state. In this configuration, the mixer 130A may have a first mixer length ML1. The actuators 10a, 10b may then apply a force F along the axial dimension AX1 in opposing directions, as shown in FIG. 4B. The deformation of the container 100 may result in a deformation of the mixer to a second deformed state corresponding to the depicted extended configuration 130B. Accordingly, the mixer 130B may have a second mixer length ML2 which may be larger than the first mixer length ML1. The flaps 135 of the mixer 130B may then deflect away from the mixer 130B to a flap height FH. As described earlier, the flap height FH in the extended configuration may correspond to an actuation amplitude. It should be appreciated that the embodiment of FIG. 4B includes flaps 135 extending in two opposing directions that are normal to the plane of the nominal plane the substrate of the mixer 130B is disposed in. In other embodiments, the flaps 135 may only extend in one direction from the plane of the mixer 130B. In other embodiments still, the flaps 135 may extend in any suitable direction from the plane of the mixer 130B as the present disclosure is not so limited. As described previously, the movement of the flaps 135 between the retracted configuration 130A and the extended configuration 130B of the mixer may induce localized fluid flow within the container which may mix the fluid.

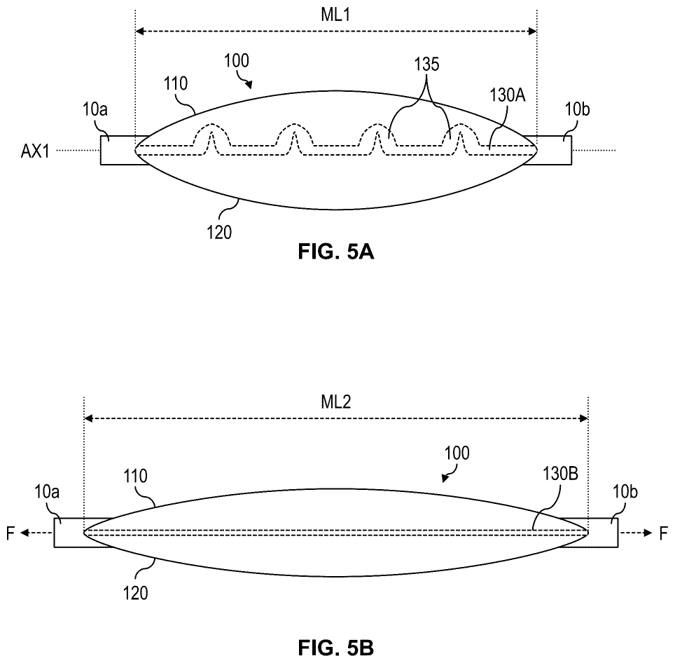

FIGS. 5A and 5B depict another embodiment of a container undergoing an actuation cycle. In this embodiment, the flaps 135 may initially be oriented in a direction that is out of plane from the substrate of the mixer in the retracted configuration 130A prior to deformation of the mixer. After a deformation is applied to the mixer by the force F applied to the mixer when the actuators 10a, 10b deform the container 100 along an axial dimension AX1 the flaps may be deformed into the nominal plane of the mixer as the substrate elongates.

It should also be appreciated that while a plurality of substantially similar flaps 135 are shown in FIGS. 5A and 4B, the flaps 135 may be a combination of different flap geometries configured to generate flow within the fluid. For example, the mixer may include different size and/or shaped flaps at different locations along the length of a mixer.

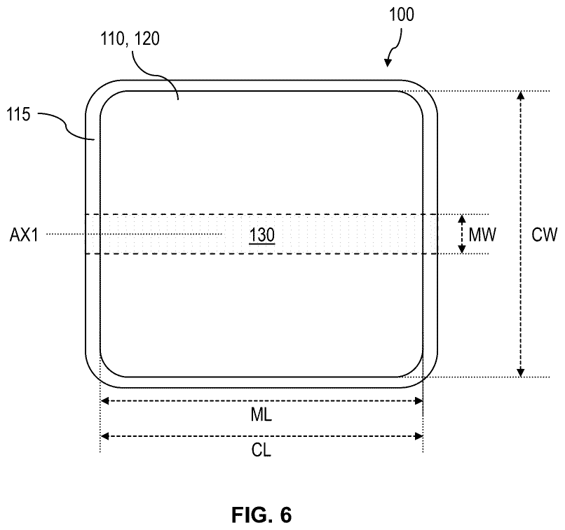

FIG. 6 depicts a top view of one exemplary embodiment of a container 100. As described earlier, the mixer 130 may be attached to the container 100 along two opposing portions of a seam 115 on opposing sides of the container. Accordingly, deformations of the container 100 may result in deformations of the mixer 130, and subsequent deflection of the flaps 135, which may mix the fluid of the container. The mixer 130 may have a mixer width MW measured normal to the axial dimension AX, which in the depicted embodiment is the longitudinal axis of the mixer. Depending on the application, the width of the mixer MW may be any suitable percentage of the container width CW. Additionally, the mixer length ML may be any suitable percentage of the container length CL as described previously. Although the mixer 130 is shown to be centrally located along the container width in FIG. 6, the mixer 130 may be located at any position along the container width, as the present disclosure is not so limited.

In the depicted embodiment of a flexible container 100, it should be appreciated that the mixer length ML may be substantially equal to the container length, CL, or other associated dimension of the container due to the mixer. This is due to the connection between the mixer 130 and the seam 115 of the container 100 on opposing sides of the container. However, as noted above, a length taken along an external surface of the flexible container between the opposing end portions of the mixer may be longer than a length of the mixer to enable the container to be filled with a fluid. However, in embodiments where the container 100 is rigid, and the mixer 130 is attached to only one portion of the container 100, the mixer length ML may be different from a corresponding dimension of the container.

It should be appreciated that the container width and length may be interchangeable, as the mixer may be arranged at any orientation on the container. For example, the mixer may span the larger dimension of a rectangular container. In another example, the mixer may span the smaller dimension of a rectangular container. In yet another example, the mixer may span an angle between adjacent sides of a rectangular container. It should be appreciated that the mixer may span any portion of the container. It should also be appreciated that while rectangular containers have been depicted in the figures, alternative container shapes, including, but not limited to, circular, triangular, or any other suitable shape may be used, as the present disclosure is not so limited.

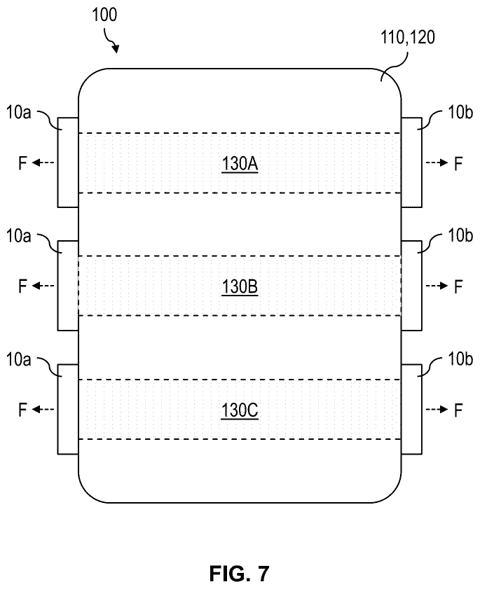

In some embodiments, the container 100 may include more than one mixer 130. For example, the container 100 may include a plurality of mixers dispersed along a length of one or more sides of the mixer, see the three mixers 130A, 130B, 130C shown in FIG. 7. In such embodiments, each mixer 130A, 130B, 130C may include a respective pair of actuators 10a, 10b configured to deform the container 100 at a local portion proximal to the axial dimension of the mixer 130A, 130B, 130C. However, embodiments in which a single actuator, or pair of actuators, are operatively coupled to each mixer are also contemplated. In instances where separate actuators are associated with the different mixers, the mixers 130A, 130B, 130C may be operated together with the processor(s) and/or controller(s) 150 (shown in FIG. 3) such that all the actuators 10a, 10b are in sync. In other embodiments, the mixers 130A, 130B, 130C may be operated sequentially, or may follow any other suitable order, as the present disclosure is not so limited. It should be appreciated that while similarly sized mixers 130A, 130B, 130C are evenly distributed along the container 100, any suitable combination of mixer sizes, arrangements, orientations, and/or distributions may be used, as the present disclosure is not so limited. For example, the container 100 may include one mixer spanning a length of the container and a second mixer spanning a width of the container.

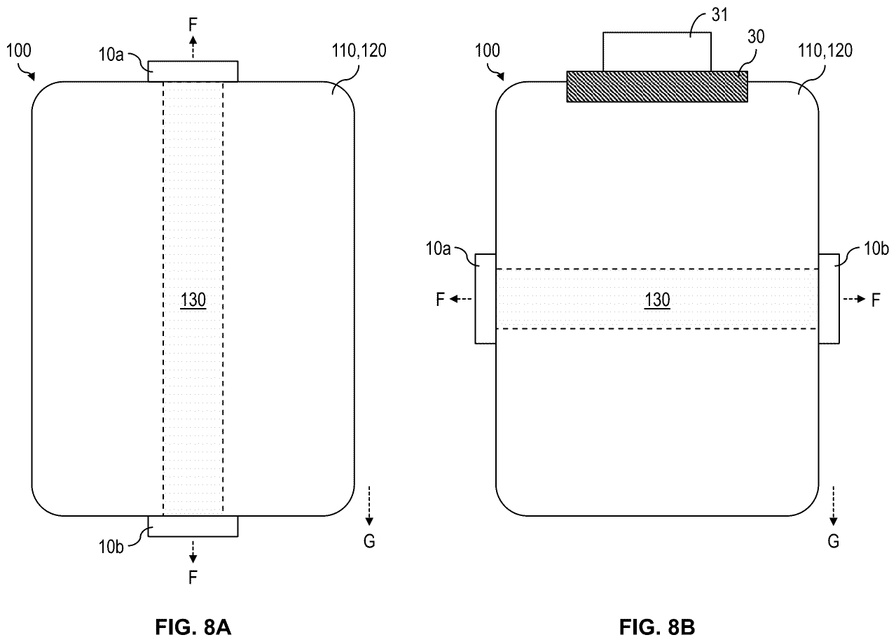

FIGS. 8A and 8B depict embodiments of a hanging container 100, as signified by the direction of gravity G. In some embodiments, the container 100 may be hanging directly from the actuators 10a, 10b, as shown in FIG. 8A. In such an embodiment, a single lower actuator may be used, and the upper actuator may be replaced by a support that is configured to be attached to and support the container. In this way, the actuators 10a, 10b, or actuator and support, may both support and deform the container 100. Of course, while a vertical orientation has been illustrated in the depicted embodiment, the containers may be hung in a horizontal orientation as the disclosure is not limited in this fashion.

In other embodiments, the container 100 may be connected to a clamp 30 or other connection that is operatively coupled to a support 31 such that the container hangs vertically below the support relative to a direction of gravity G. Accordingly, the container 100 may be supported even when not engaged with the actuators 10a, 10b which may be engaged with the mixer 130. Alternative hanging embodiments are also contemplated as described previously including, for example, horizontal hanging arrangements.

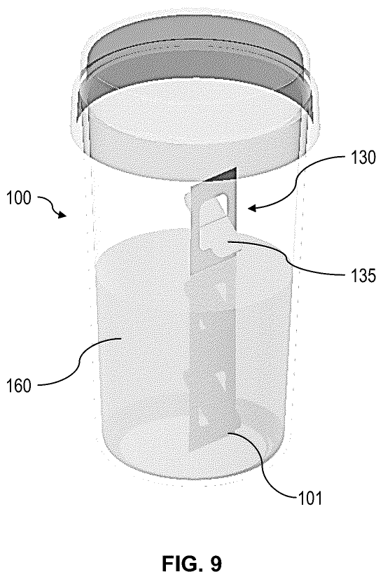

FIG. 9 depicts an exemplary embodiment of a rigid container 100 with a mixer 130 disposed at least partially within the container and at least partially immersed in a fluid 160 contained in an inner volume of the container. As described previously, when the mixer 130 is located in a rigid container 100, the mixer 130 may only be connected to the container 100 at one portion to allow the mixer 130 to sufficiently deform and allow the flaps 135 to deflect from the mixer 130 in response to stimuli (e.g. mechanical deformation or other stimuli described earlier). For example, the mixer 130 may be attached to the rigid container 100 at an end portion 101 that is disposed adjacent to and connected with a base of the container 100. However, it should be appreciated that the mixer 130 may be attached to the rigid container 100 at any suitable location, as the present disclosure is not so limited. In some embodiments, the mixer 130 may not be attached to the rigid container 100 and may be dispersed within the fluid 160. For example, the mixer 130 may be made of a material that allows the mixer 130 to deform in response to suitable external stimuli without contacting the rigid container 100.

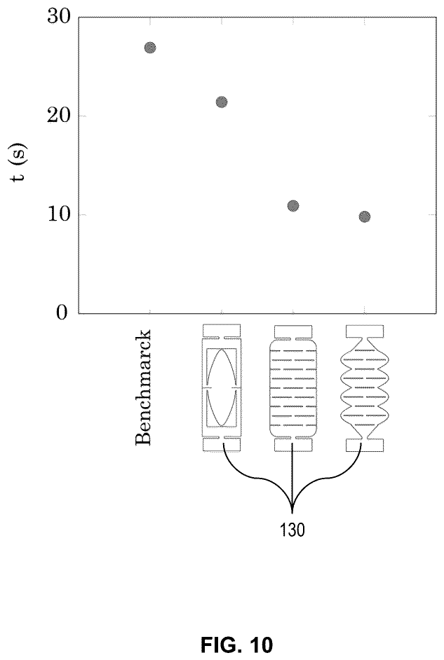

FIG. 10 is a plot of mixing time t in seconds s characterized by a decolorization method (i.e. iodometry) for various embodiments (i.e. shapes) of the mixer 130. In these processes, an actuation frequency of 2 Hz was used, with an actuation amplitude of 15 mm. The decolorization protocol from ISBN: 978-3-89746-171-0 was used to characterize the mixing time of the different mixers 130. It should be appreciated that all embodiments of the mixer 130 depicted in FIG. 10 reduced the mixing time t of the container. This reduction of mixing time t may improve the overall throughput and efficiency of the laboratory or environment in which the mixers described herein are used.

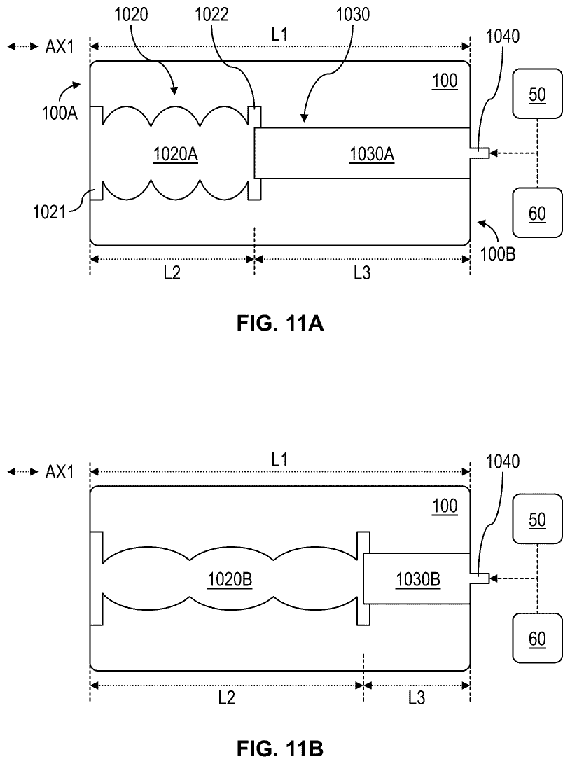

FIGS. 11A-11B show, according to some embodiments, a mixing system including a mixer 1020 and actuator 1030 positioned in a container 100. The mixer 1020 may be deformable along an axial direction AX1 between a retracted state 1020A and an extended state 1020B due to movement of the actuator 1030 between its extended state 1030A and contracted state 1030B respectively. The movement of the actuator 1030 may be controlled by one or more controllers and processors 60 configured to control one or more inputs 50 operatively coupled with the corresponding actuator (e.g., fluid source, electrical signal, etc.). In this way, the controllers and processors 60 may drive the actuator to deform along axial direction AX1 to deform the mixer 1020. The inputs 50 may be in communication (e.g., fluidically, electrically) with the actuator 1030 through at least one port 1040 in the case of a pneumatic or hydraulic system though other appropriate connections may be used for other types of actuators (e.g., one or more electrical contacts). In some embodiments, the mixer 1020 may include one or more features (e.g., flaps) which may deflect out of plane when the mixer 1020 is axially deformed, which may result in fluid flow within the container 100.

The mixing system depicted in FIGS. 11A-11B represent serially arranged mixer and actuator assemblies. For example, a first tab 1021 tab 1021 of the mixer 1020 may be coupled or fixed (either removably or permanently) to the container 100 at a first end portion of the container 100A, and a second tab 1022 of the mixer 1020 may be coupled or fixed (either removably or permanently) to the actuator 1030. The actuator 1030 may in turn be coupled to or fixed (either removably or permanently) to a second end portion of the container 100B. Accordingly, an axial length L1 of the container 100 may be substantially equal to the sum of an axial length L2 of the mixer 1020 and an axial length L3 of the actuator 1030. Of course, embodiments in which connecting features are positioned in between the various components (e.g., between the container and mixer, between the mixer and actuator, between neighboring mixers, between neighboring actuators) are also contemplated, such that the sum of the mixer axial length L2 and actuator axial length L3 may be less than the container axial length L1.

It should be appreciated that depending on the specific construction and arrangement of the mixing system and the type of actuator used, the mixer 1020 and/or actuator 1030 may each have an axial length of any suitable proportion of the container axial length L1. For example, the mixer axial length L2 in either the retracted state 1020A or expanded state 1020B may be at least 10%, 20%, 30%, 40%, 50%, 60%, 70%, 80%, 90%, 100%, and/or any other suitable percentage of the container axial length L1. The mixer axial length L2, in either the retracted state 1020A or the expanded state 1020B may be less than or equal to 100%, 90%, 80%, 70%, 60%, 50%, 40%, 30%, 20%, 10%, and/or any other suitable percentage of the container axial length L1. Combinations of the foregoing are also contemplated, such as a mixer axial length L2 between 10% and 100%, 20% and 90%, and/or any other suitable range of percentages of the container axial length L1 in either the retracted state 1020A or the expanded state 1020B.

Similarly, the actuator axial length L3 in either the extended state 1030A or contracted state 1030B may be at least 10%, 20%, 30%, 40%, 50%, 60%, 70%, 80%, 90%, 100%, and/or any other suitable percentage of the container axial length L1. The actuator axial length L3, in either the extended state 1030A or contracted state 1030B may be less than or equal to 100%, 90%, 80%, 70%, 60%, 50%, 40%, 30%, 20%, 10%, and/or any other suitable percentage of the container axial length L1. Combinations of the foregoing are also contemplated, such as an actuator axial length L3 between 10% and 100%, 20% and 90%, and/or any other suitable range of percentages of the container axial length L1 in either the extended state 1030A or contracted state 1030B.

It should be appreciated that the mixer 1020 and/or actuator 1030 may undergo any suitable magnitude of axial deformation between an extended and retracted configuration along axial direction AX1. The mixer 1020 and/or actuator 1030 may undergo at least 5%, 10%, 20%, 30%, 40%, 50%, 60%, 70%, 80%, 90%, 100%, 120%, 150%, 200%, 300%, 500%, 750%, and/or any other suitable axial deformation, in either compression or extension, along axial direction AX1. The mixer 1020 and/or actuator 1030 may also undergo less than or equal to 750%, 500%, 300%, 200%, 150%, 120%, 100%, 90%, 80%, 70%, 60%, 50%, 40%, 30%, 20%, 10%, 5%, and/or any other suitable axial deformation, in either compression or extension, along axial direction AX1. Combinations of the foregoing are also contemplated, such as a mixer 1020 and/or actuator 1030 which may undergo between 5% and 750%, 20% and 200%, 10%, and 500%, and/or any other suitable axial deformation, in either compression or extension, along axial direction AX1. Of course, depending on the actuator type and requirements of the mixing system, the mixer and/or actuator may undergo any suitable magnitude of axial deformation, as the present disclosure is not so limited.

It should be appreciated that in the serial configuration shown in FIGS. 11A-11B, the mixer deformation and actuator deformation may be complementary. For example, if the actuator axially deforms 50%, such that its axial length increases, the mixer may axially deform by an equal magnitude in an opposing fashion. In other words, an axial extension of the actuator may result in an axial compression of the mixer.

In some embodiments, the actuator 1030 may undergo uniaxial deformation along direction AX1, as shown in FIGS. 11A-11B. However, embodiments in which the actuator undergoes multiaxial deformation, including along axial direction AX1 are also contemplated.

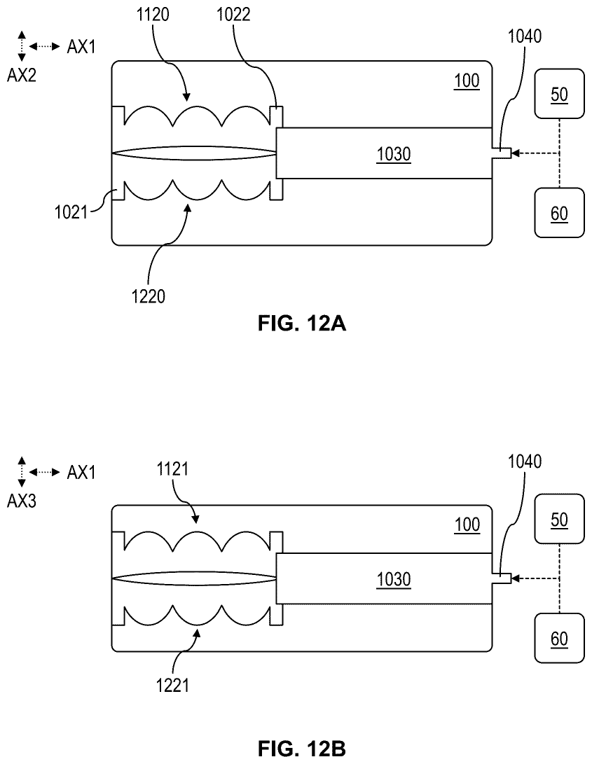

FIGS. 12A-12B depict a mixing system with an actuator 1030 and two or more mixers coupled to one another and to the actuator (e.g., through tabs 1022), such that deformation of the actuator 1030 may result in deformation of both or all mixers. In some embodiments, the mixers 1120 may be arranged along a plane formed by axial directions AX1 and AX2, as shown in FIG. 12A. In this way, the mixers may induce flow in different regions of the container 100, which may enhance the overall mixing efficiency of the system. In some embodiments, mixers 1121, 1221 may be arranged along a plane formed by axial directions AX1 and AX3, as shown in FIG. 12B to help induce flow in the upper and lower regions of the container 100. It should be appreciated that any suitable number of mixers greater than or equal to one mixer may be employed to enhance the mixing efficiency. These mixers may be arranged in any suitable fashion within the container along any plane to help mix different regions of the fluid within the container. As shown in FIGS. 12A-12B, the mixers may all be actuated with one actuator 1030. In other embodiments, multiple actuators may be employed to actuator the mixers. In some embodiments, the mixer may be monolithic, but may include portions which mix different portions of the container, as shown in the exemplary embodiment of FIG. 4B.

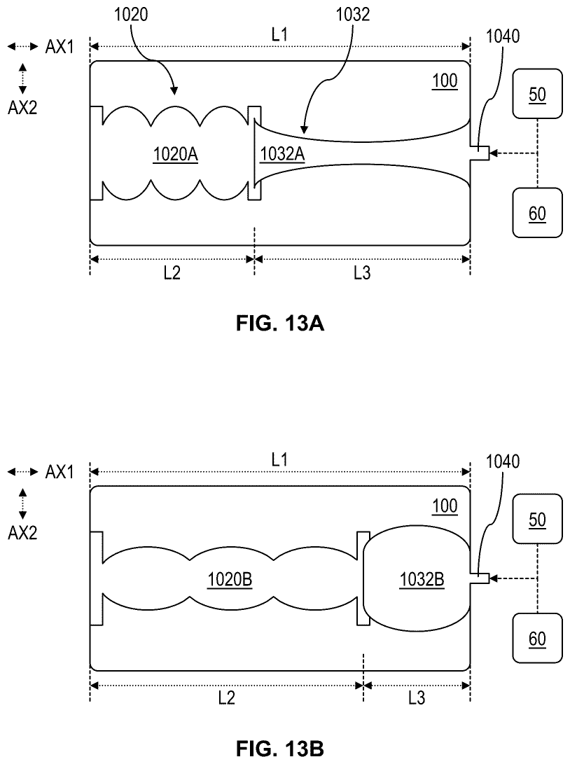

FIGS. 13A-13B depict a mixing system employing a pneumatic actuator 1032 according to some embodiments. As described previously with respect to FIGS. 11A-11B, the mixing system may include a mixer 1020 and actuator 1032 positioned inside of a container 100. The mixer 1020 and actuator 1032 may be coupled to one another in a manner that allows the actuator to deform the mixer 1020, which may, in some embodiments, induce fluid flow within the internal volume of the container 100.

The pneumatic actuator 1032 may be fluidically connected to an input source (e.g., air) 50 through one or more ports 1040. The pneumatic actuator 1032 may include a flexible tubular bladder which may be inflated by the input source 50. The bladder may be encased in a woven or braided shell which may serve to convert the radial expansion of the member (upon inflation) to uniaxial contraction. For example, FIG. 13A depicts the pneumatic actuator 1032 in an extended state 1032A, wherein fluid from the input source 50 is inflating the inner bladder, resulting in axial expansion of the actuator. FIG. 13B depicts the pneumatic actuator 1032 in a contracted state 1032B, wherein fluid is driven out of the inner bladder, resulting in axial contraction of the actuator 1032 along the axial direction AX1. As shown in FIGS. 13A-13B, it should be appreciated that a pneumatic actuator 1032 may also undergo deformation along a secondary axial direction AX2 complementary to its deformation along the axial direction AX1. In some embodiments, the pneumatic actuator 1032 may operate akin to an artificial muscle or a Mckibben muscle. Of course, other modes of pneumatic actuator are also contemplated.

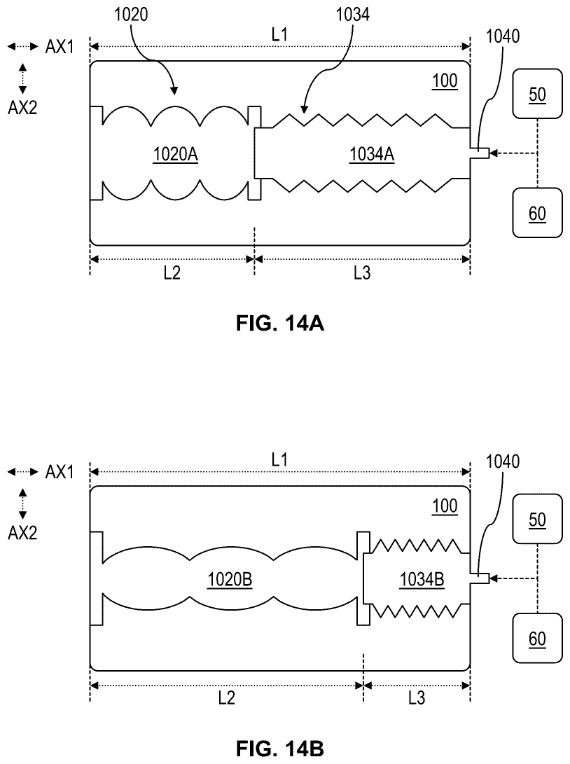

FIGS. 14A-14B depict a mixing system with a soft deployable linear actuator 1034, driven by a fluidic input source 50. In some embodiments, the soft actuator 1034 may be structured similarly to an accordion, with one or more bellows, with an internal cavity. The internal cavity of the soft actuator 1034 may be inflatable, such that fluid flow from the input source 50 (e.g., air, water, etc.) into the actuator 1034 may induce axial expansion, and fluid flow out of the actuator 1034 may induce axial contraction. Therefore, the actuator 1034 may linearly deform based on its internal fluid pressure. In some embodiments, the input source 50 may include one or more pumps (e.g., pneumatic pumps), configured to cyclically inflate/deflate the actuator 1034. The pump may be controlled with one or more processors 60 which depending on the embodiment may either directly control the pumps and/or one or more pneumatic controls (e.g., valves, variable restrictions, etc.) not depicted.

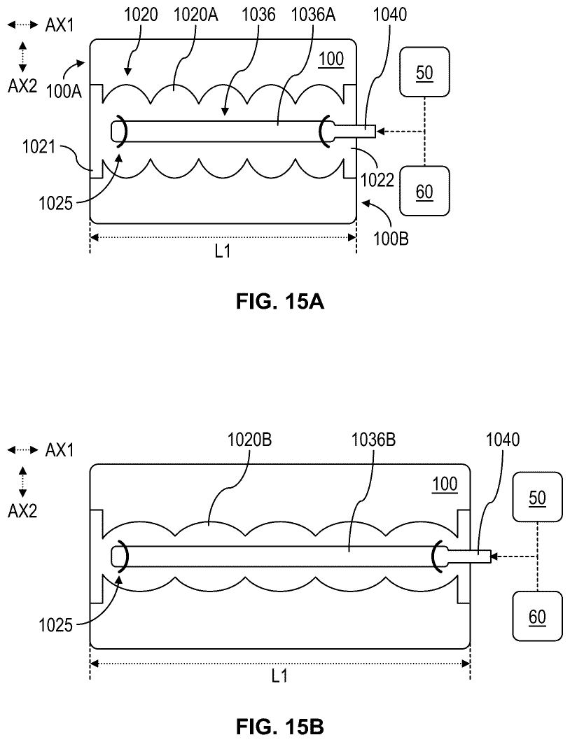

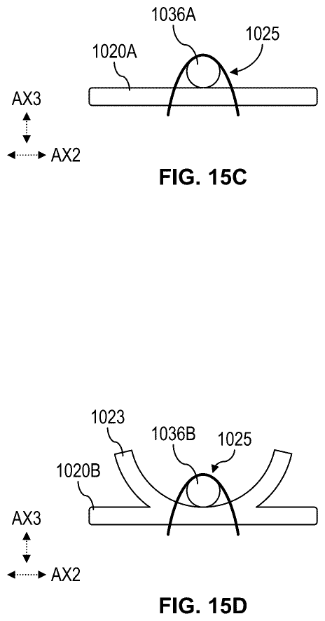

FIGS. 15A-15D depict a mixing system with a mixer 1020 and actuator 1036 in a parallel configuration. As shown in the figures, the mixer 1020 and actuator 1036 may be coupled to one another at connections 1025 located on opposing sides of the container. The connections may be removable or permanent attachment sites for the actuator and mixer. The actuator 1036 may be moveable between a contracted state 1036A, as shown in FIG. 15A to an extended state 1036B, as shown in FIG. 15B. The mixer 1020 may axially deform along with the actuator due to the connections 1025. In some embodiments, the actuator 1036 may be driven by one or more input sources 50 in communication with processors and/or controllers 60, which may control various parameters of the actuation process, such as duration, frequency, magnitude, etc.

In some embodiments, as shown in FIGS. 15A-15B, the mixer 1020 may be coupled to or fixed to the container 100 at the container's first end 100A first end 100A with a first tab 1021 tab 1021, and at the container's second end 100B with a second tab 1022. Accordingly, in embodiments represented by FIGS. 15A-15D, the container 100 may deform along with the actuator 1036. For example, as shown in FIGS. 15A-15B, an axial length L1 of the container 100 may change when the actuator 1036 moves between its contracted state 1036A and extended state 1036B. Of course, embodiments with a parallel arrangement of one or more mixers and one or more actuators with a rigid (i.e., non-flexible) container are also contemplated.

FIGS. 15C-15D depict the mixing system of FIGS. 15A-15B viewed along the axial direction AX1. As shown, the mixer may move between a retracted state 1020A and extended state 1020B when the actuator moves between its contracted state 1036A and extended state 1036B, due to one or more connections 1025. In some embodiments, the mixer may include one or more flaps 1023 flaps 1023, which may deflect out of plane when the mixer is in its extended state 1020B. This out of plane deflection of the flaps 1023 may induce local fluid flow within the container. It should be appreciated that any suitable arrangement of flaps and/or any other suitable features may be employed to achieve fluid agitation upon axial deformation of the mixer.

In some embodiments, the actuator 1036 depicted in FIGS. 15A-15D may be a pneumatically actuated tube in fluid communication with an input source 50, which may be configured to flow fluid (e.g., air) in and out of the tube to deform the actuator 1036. In some embodiments, the tube may undergo more axial deformation (e.g., along axial direction AX1) than radial deformation. In other words, the tube may be structured to maximize the axial deformation of the actuator and minimize radial deformation for more efficient actuation.

In some embodiments, the actuator 1036 depicted in FIGS. 15A-15D may be formed of a shape memory material. The actuator 1036 may therefore be configured to axially deform (e.g., uniaxially elongate) in response to a temperature change, which can be applied through input source 50. Due to one or more connections 1025 between the mixer 1020 and actuator 1036, the uniaxial deformation of the actuator 1036 may result in axial deformation of the mixer 1020, which may induce fluid flow in the container 100. As described previously, in some embodiments, the actuator 1036 may be coated with an outer layer which may isolate the actuator from the surrounding environment. It should be appreciated that any suitable shape memory material which undergoes sufficient axial deformation within a desired temperature range for a given application may be employed, as the present disclosure is not limited by the material composition of the shape memory alloy. In embodiments where the mixing system is used for cell culture, the shape memory material may be selected to undergo axial deformation at physiologically tolerable temperatures.

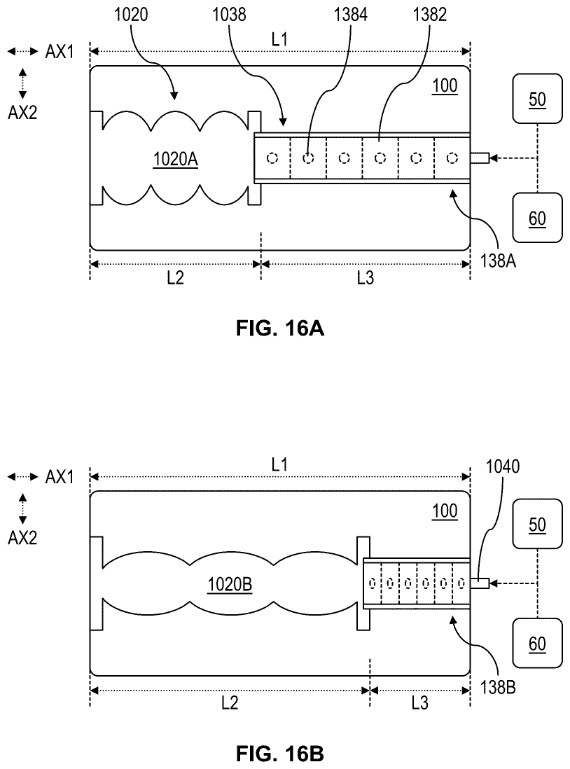

FIGS. 16A-16B depict a mixing system with a mixer 1020 and an origami actuator 1038 arranged in series, both positioned inside of a container 100. The origami actuator 1038 may include a rigid but deformable internal structure 1382 encased in a flexible bladder. The origami actuator 1038 may be movable between an extended state 1038A when the bladder is inflated (e.g., through port 1040 and input source 50), and a contracted state 1038B when the bladder is deflated. In some embodiments, the internal structure 1382 may include one or more holes 1384 to reduce the hydraulic resistance of fluid (e.g., air, water) flowing into and out of the bladder.

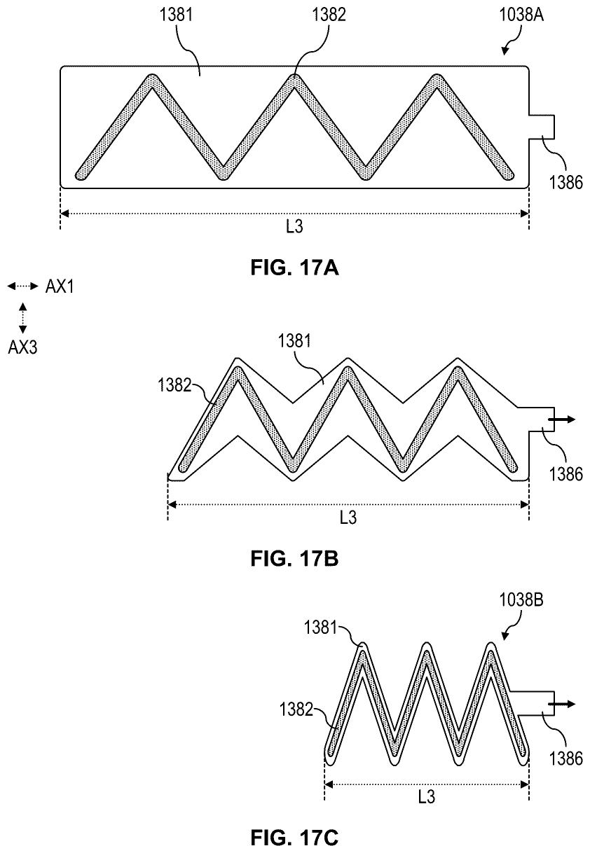

FIGS. 17A-17C depict operation of an origami actuator according to some embodiments. As shown, the origami actuator may include a rigid deformable internal structure in the form of a rigid foldable internal structure 1382 that is configured to be folded along a plurality of joints. For example, the rigid internal structure may include a series of planar segments that are serially connected to one another by corresponding living hinges, or another appropriate rotatable connection, disposed between the adjacent planar segments. The rigid foldable structure may be disposed within a bladder 1381 that extends along a length and at least partially surrounds the rigid foldable structure. The bladder 1381 may be flexible, such that it may be inflated/deflated with a fluid (e.g., air, water) that is flowed into and out of the internal volume of the bladder through a port 1386. In some embodiments, port 1386 may be in fluid communication with port 1040 shown in FIGS. 16A-16B, and subsequently input source 50. The internal structure 1382 may be formed of a folded sheet of rigid material such that it may be axially deformable through bending of its flexible joints at each fold. The bladder 1381 may be sufficiently flexible to conform around the internal structure 1382 upon deflation.

It should be appreciated that the bladder 1381 may be formed of any suitable flexible material or combination of materials suitable for the intended application of the mixing system. The bladder 1381 may be sufficiently sealed to reduce the risk of fluid flow from the bladder 1381 to the internal volume of the container, and similarly from the internal volume of the container to the bladder.

FIG. 17A shows the origami actuator in its extended state 1038A, wherein the bladder 1381 is substantially inflated. The actuator may have an axial length L3 along axial direction AX1, which may be reduced upon deflation of the bladder 1381, as shown in FIGS. 17B-17C. When fluid is flowed (e.g., pumped) out of the bladder 1381 through an outlet port 1386, the bladder 1381 may conform about the internal structure 1382, which may also be axially or linearly deformed due to the out flow of fluid from the bladder 1381. Accordingly, the overall axial length L3 of the actuator may be reduced (see axial length L3 of FIG. 17C in comparison with FIG. 17A), which may urge axial deformation (e.g., expansion) of a mixer connected to the actuator, as shown in FIGS. 16A-16B.

The internal structure 1382 (including holes 1384, shown in FIGS. 16A-16B) may be formed using any suitable material and technique. In some embodiments, the internal structure may be laser cut, folded, and subsequently heat sealed to the bladder 1381 to form the actuator. The structural weakness of the folds allows the internal structure to axially deform similar to an accordion, during outflow of fluid from the bladder 1381.

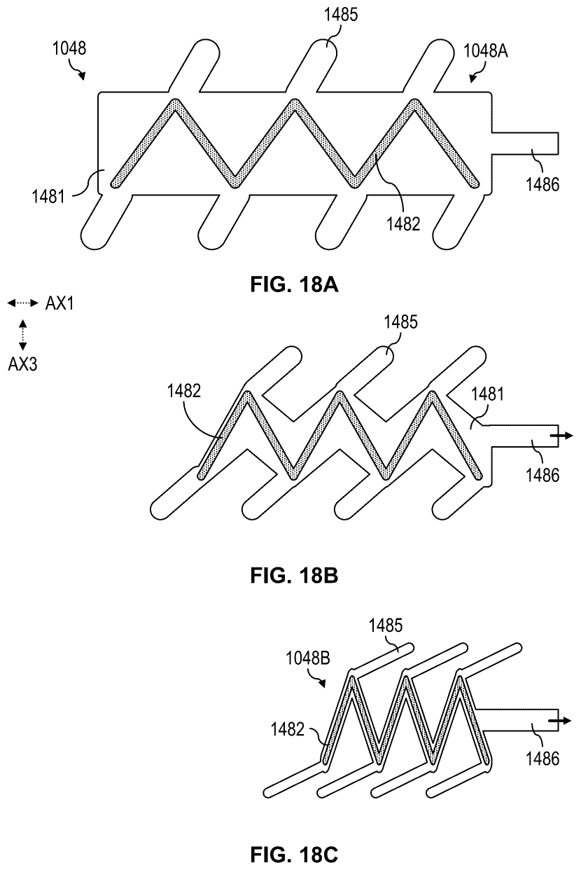

FIGS. 18A-18C depict an origami actuator 1048 according to other embodiments. The actuator 1048 and its internal structure 1482 may be similar in operation to actuator 1038 outlined in FIGS. 16A-17C, but may also include one or more paddles 1485, which may be in fluid communication with an inflatable bladder 1481. The paddles 1485 may be arranged in any suitable fashion along the actuator 1048, and may serve to enhance mixing efficiency within the container. As shown in the sequence of FIGS. 18A-18C, the paddles 1485 may be inflatable along with the bladder 1481, such that out flow of fluid from the bladder may result in a deflation of the paddles and subsequent actuation. Specifically, the paddles may be inflatable structures that extend outwards from one or more exterior portions of the bladder 1481. Therefore, as the bladder is inflated, the paddles may move with the bladder and extend further out into the fluid which may provide additional mixing of the fluid as the paddles move through the fluid into the fully inflated configuration. In some embodiments, the paddles may pivot along with the inflation/deflation cycle, inducing flow within the container (not shown). In some embodiments, the inflation of the paddles themselves may induce localized fluid flow. It should be appreciated that non-inflatable paddles which pivot or otherwise move along with the deflation/inflation of the bladder 1481 are contemplated. The paddles 1485 shown in FIGS. 18A-18C may be combined with any of the actuators and/or mixers described herein, and not limited to the origami actuators.

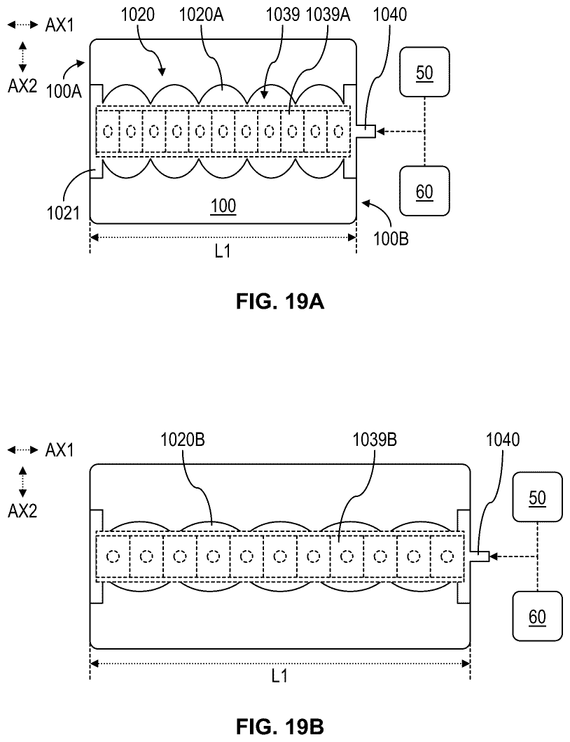

FIGS. 19A-19B depict an origami actuator 1039 and mixer 1020 in a parallel configuration, according to some embodiments. The actuator 1039 may have a similar structure to the origami actuator depicted in FIGS. 16A-17C, with a rigid, foldable internal structure encased in a flexible inflatable bladder. In the embodiments represented by FIGS. 19A-19B however, the actuator 1039 may overlie the mixer 1020, such that the actuator 1039 may be extended to extend the mixer and contracted to retract the mixer. In contrast, the arrangement of the origami actuator 1038 and mixer 1020 in series, as shown in FIGS. 16A-17C, results in the retraction of the mixer when the actuator is extended, and the extension of the mixer when the actuator is contracted. The actuator 1039 of FIGS. 19A-19B may be coupled to or fixed (removably or permanently) to the container 100 at one or more tabs. For example, the actuator 1039 and mixer 1020 may be attached to a first end 100A of the container with a tab 1021. Similar to the parallel configuration described earlier with respect to FIGS. 15A-15D, the container 100 may be sufficiently flexible to deform along with the actuator and mixer. For example, the container axial length L1 taken along axial direction AX1 may be greater at the origami actuator's extended state 1039B (FIG. 19B) than at the origami actuator's contracted state 1039A (FIG. 19A). Of course, embodiments in which a rigid container 100 is employed with a parallel actuator/mixer assembly are also contemplated, as the present disclosure is not so limited.

It should be appreciated that while various pneumatic actuators have been described for actuation of the mixers, any suitable mechanisms capable of applying a deformation to the mixers to induce movement between the retracted and extended configurations may be used as the disclosure is not so limited. For example, electromagnetic actuation, pneumatic actuation, light-responsive actuation, and/or any other appropriate type of actuation method may be used as the present disclosure is not so limited.

In some embodiments, a mixing system may employ a uniaxial dielectric elastomer actuator. The uniaxial dielectric actuator may include a plurality of stacked thin dielectric film pieces, coated with compliant electrodes. The actuator may be used in serial configuration (see FIGS. 11A-11B) with a mixer, and may be in electrical communication with an input source (e.g., power source) through a port (see port 1040 of FIGS. 11A-11B). An actuation voltage may be applied to the actuator, resulting in electrostatic field induced displacement normal to the plane of the electrodes. The stacked dielectric films may serve as a series of compliant capacitors electrically connected in parallel with alternating polarities of each layer. The actuation voltage may therefore be applied to two separated compliant electrodes connected to the associated conductive layers. Accordingly, the dielectric elastomer actuator may convert electrical energy into mechanical work to axially deform the mixers to induce flow within the container. The dielectric elastomer actuator may be formed of any suitable material, but may also include a coating or outer layer to reduce the risk of fluid flow into the actuator from the internal volume of the container.

In other embodiments, a uniaxial dielectric actuator may include a roll or tube actuator. In the rolled configuration, the actuator may be formed of a flat elastomeric sheet with complementary electrodes positioned on either face of the flat sheet. The flat sheet may be rolled to approximate the two faces of the flat sheet. An actuation voltage may be applied to the rolled actuator (e.g., through a power source 50 and port 1040, as shown in FIGS. 11A-11B) to axially deform the actuator, which may, in turn, deform a mixer. In some embodiments, the actuator may be in a tubular configuration, substantially similar to the rolled configuration, but with a single roll instead of a plurality of coaxial rolls. Of course, other arrangements or configurations of uniaxial dielectric elastomer actuators are also contemplated, as the present disclosure is not so limited.

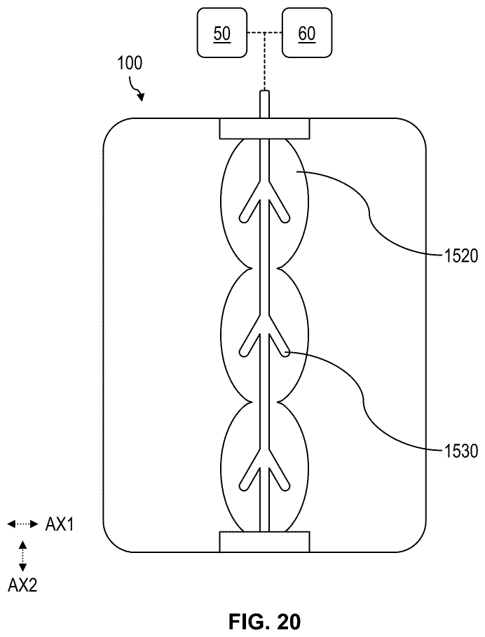

FIG. 20 shows a mixing system employing a pneumatic soft actuator 1530 according to some embodiments. The mixing system may include an inflatable soft actuator 1530 with an internal channel configured for fluid flow. The internal channel may be integrated within the actuator. The actuator 1530 may be coupled to a mixer 1520, which may have properties akin to any of the mixers described herein. The soft actuator 1530 may be designed to undergo out of plane deformation during inflation with fluid from an input source 50 and controller(s) and/or processor(s) 60. For example, the actuator 1530 may include one or more ridges to induce a particular direction of inflation to actuate the mixer and induce flow within the container. The inflation and subsequent actuation of the actuator may induce planar and/or out-of-plane deformation of the mixer 1520, along the plane formed by axial directions AX1 and AX2. In some embodiments, high pressure fluid within the actuator 1530 may cause the mixer 1520 to extend, while low pressure fluid within the actuator 1530 may cause the mixer 1520 to retract. The cycling between high and low pressure may be achieved through inflation and deflation of the actuator. Any suitable soft actuator may be employed to deform the mixer, as the present disclosure is not so limited. The soft actuator may be formed of a flexible and/or elastic material (e.g., silicone, rubbers) to facilitate its actuation.

In some embodiments, the actuator 1530 may be formed as inflatable channels within the mixer 1520, such that the actuator may be integrated directly within a body of the mixer. The changes in inflation of the actuator 1530 may therefore apply pressure to the mixer 1520 and induce changes in configuration. In other embodiments, the actuator 1530 may be a separate component relative to the mixer 1520, and may be affixed to the mixer through any suitable bonding (e.g., adhesive, welding, melting) technique. The actuation of the actuator may similarly apply pressure to the mixer and induce mixing within the container. It should be appreciated that any suitable arrangement of the mixer and the actuator are contemplated, as the present disclosure is not so limited.

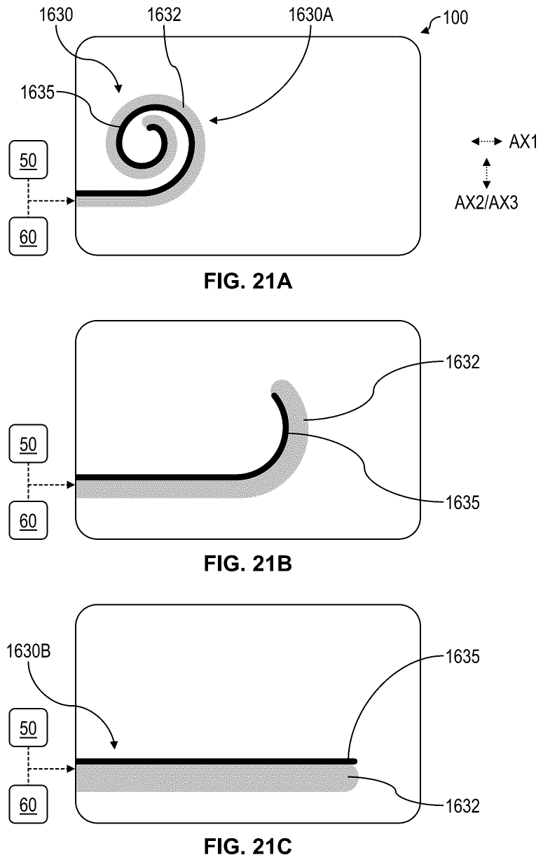

FIGS. 21A-21C show pneumatic rolled actuators 1630 according to some embodiments. A mixing system may include one or more rolled actuators 1630 arranged in a container (flexible or rigid) to help induce fluid flow. The actuator may include an energy storage member 1635 arranged parallel to an inflatable body 1632. For example, the energy storage member may be a torsional spring or other coiled elastic structure that may be deformed between an unbiased coiled configuration and an extended configuration. The energy storage member 1635 and the inflatable body 1632 may be coupled to one another, such that inflation of the inflatable body may overcome the energy stores within the energy storage member 1635 and deform the assembly. As shown in the sequence of FIGS. 21A-21C, inflation of the body 1632 (e.g., from input source 50 and controller(s) and/or processor(s) 60) may unfurl or unroll the assembly from its original rolled configuration, shown in FIG. 21A, to a partial unrolled configuration, shown in FIG. 21B, to a further fully unrolled configuration, shown in FIG. 21C. The energy storage member 1635 may be pre-formed in the fully rolled configuration, such that deflation of the body 1632 may revert the system back to its original rolled configuration. Accordingly, repeated cycles of inflation and deflation may induce fluid flow within the container. In some embodiments, the actuator 1630 may operate akin to a party horn.

The actuator 1630 may be arranged along any suitable plane as may be spatially efficient for the application to induce highly efficient fluid flow within the container. The mixing time of the system may be controlled by the rolling and unrolling speed as well as the frequency of rolling/unrolling of the body 1632, which may both be controlled by air pressure valves as will be described in detail below.

It should be appreciated that in some embodiments, the actuator 1630 of FIGS. 21A-21C may be used to induce fluid flow without the use of mixers. More than one roll actuator 1630 may be used in one container in any suitable arrangements to enhance mixing. In other embodiments, the actuator of FIGS. 21A-21C may be integrated with any of the mixers described herein.

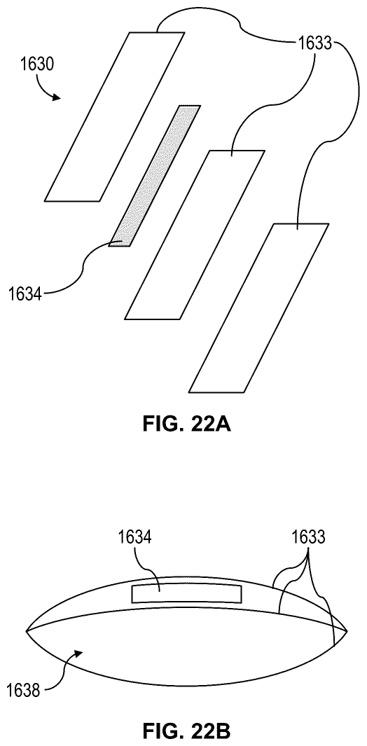

FIGS. 22A-22B show a deconstructed roll actuator 1630 and a cross-sectional view of said actuator, according to some embodiments. The actuator 1630 may be formed of one or more flexible sleeves 1633 and an energy storage member 1634. In some embodiments, the energy storage member may be a constant force spring, although other embodiments of an energy storage member are also contemplated. The sleeves 1633 may be arranged to form one chamber for the energy storage member 1635, and another chamber 1638 for the fluid, as shown in FIG. 22B. The sleeves may be sealed to reduce the risk of leakage into and/or out of the actuator into the container.

In some embodiments, the system of FIGS. 21A-22B may be inflated with a pressure of approximately 0.4 bar. Accordingly, the sleeves may be formed of a material which may inflate and deform at this (and/or at any other suitable pressure). The pressure may be selected to overcome the pre-formed energy storage member. Accordingly, the inflation pressure of the actuator may be any suitable pressure, greater than and less than 0.4 bar, as the present disclosure is not so limited. It should be appreciated that the inflation pressure of the roll actuator may also depend upon properties of the fluid arranged in the container (e.g., viscosity and density). As will be described below, the speed of rolling/unrolling process may be controlled by a needle valve that controls the air flow in and out of the actuator. In some embodiments, the frequency of the cycles may be controlled with a separate valve.

In some embodiments, the actuators of the present disclosure described to employ pneumatic actuation may instead, or in combination with, use shape memory alloy materials actuated through electrical voltage. The materials may be heated to alternate between the various actuation configuration to induce flow (or actuate the mixer(s) to induce flow) within the container. To limit the heat transfer to the fluid within the container, thermally insulating actuator sleeve materials may be employed to retain the contents of the container at suitable temperatures.

It should be appreciated that any of the actuators described herein may be used to mix the fluid independent without the use of mixers. The actuators arranged inside the container may sufficiently induce flow and mix the contents of the container. Embodiments employing mixers and actuators as previously described are contemplated.

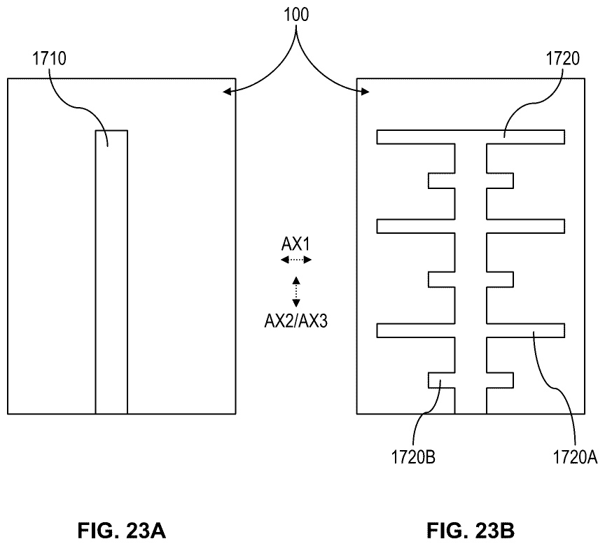

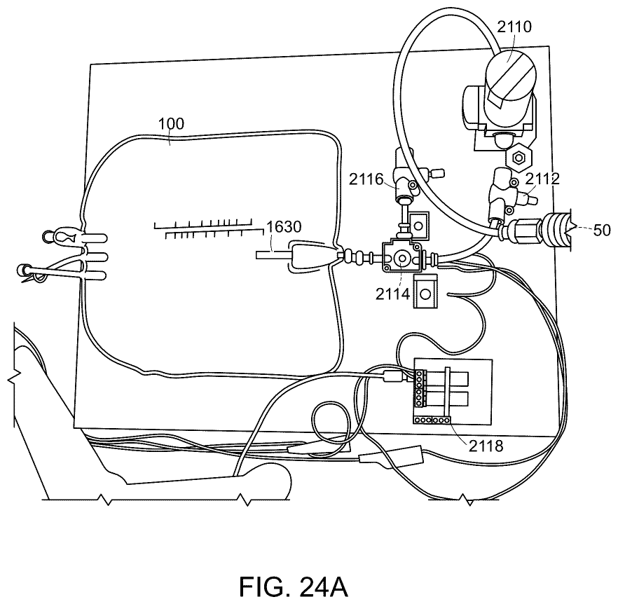

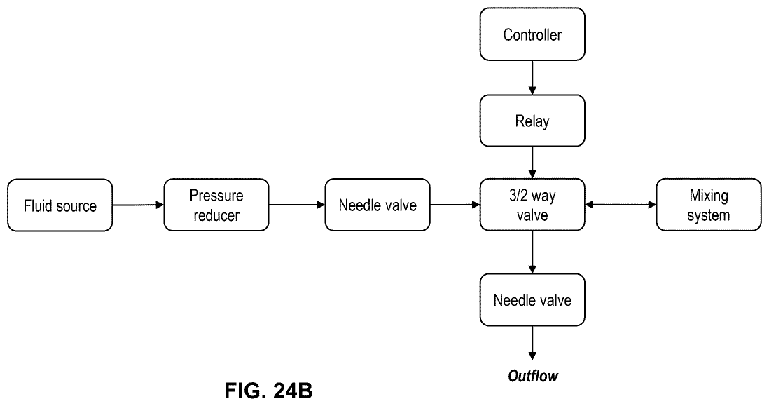

In some embodiments, the mixers and/or actuators may be arranged in a fractal fashion to enhance the mixing efficiency. As shown in FIG. 23A, in some embodiments, the mixers and/or actuators 1710 may be arranged in a linear fashion extending in one direction. To enhance mixing efficiency, fractally shaped mixers and/or actuators 1720, as shown in FIG. 23B, may be employed in combination with or as an alternative to the linear actuators 1710. The various structures of a fractal mixer and/or actuator may induce fluid flow in various portions of the container to enhance efficiency. In some embodiments, the fractal structure 1720 may include one or more portions 1720A, 1720A which may be actuated through the same or different actuation mechanism to achieve a desired flow pattern throughout the container. It should be appreciated that the fractal structure shown in FIG. 23B is exemplary, and represents any suitable multidirectional mixer and/or actuator to help enhance mixing efficiency. FIG. 24A shows an exemplary control system for any of the mixing systems described herein. The control system may be compact (e.g., small footprint) to facilitate the use of the mixing system in a variety of applications. In some embodiments, fluid (e.g., compressed air or a compressor connected to a fluid source) may flow from an input source 50 into a pressure reducer 2110 and a needle valve 2112, both of which may be operated electronically with a controller 2118 and relay to control the actuator behavior. The control system may also include a 3/2 way valve 2114 to control the frequency of the actuation cycle and thereby, the mixing time. In some embodiments, a needle valve 2116 may be employed to control the flow rate of the fluid from the input source out of the actuator, which may also contribute to the frequency of the actuation cycle. As described previously, the cycle frequency may contribute to the mixing speed as well as the shear stress of the fluid within the container. Accordingly, the frequency may be adjusted to suit the application. For example, if the container includes cells, the frequency may be controlled to apply an acceptable level of shear stress to the cells during mixing. FIG. 24B is a block diagram of the control system of FIG. 24A for improved visualization.

It should be appreciated that the control system of FIGS. 24A-24B is exemplary and any other suitable control system to control the actuators and/or mixers of the present disclosure may be employed.

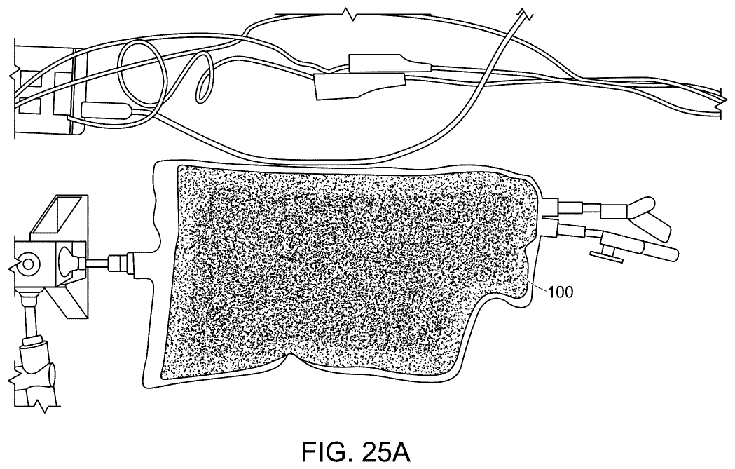

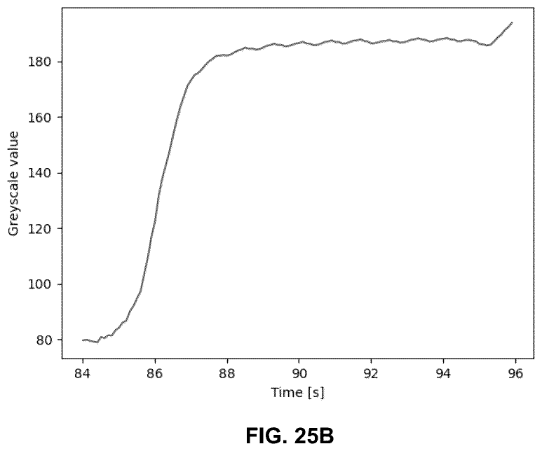

The mixing behavior of the mixing systems described herein may be evaluated using an automated image analysis system. An exemplary system includes the evaluation of gray-scale levels of images after mixing to reduce human error in the analysis. An exemplary data analysis process may include, loading a recorded video of a container having a mixing system within. Extracting a region of interest for one or more frames of the video. An exemplary frame and container 100 is shown in FIG. 25A. Each frame may be saved, and the average RGB value of the region of interest may be converted to a greyscale intensity value. This data may be plotted as a function of time, as shown in the exemplary plot of FIG. 25B. Signal processing such as data smoothing (e.g., cubic spline interpolation) may be employed to improve the signal quality. In some embodiments, outlying events, such as focus and light intensity variations may be discarded. From the remaining data, the complete mixing time may be extracted, defined as the time after which the variations in greyscale value are smaller than 1%. In some embodiments, other mixing times may also be extracted, such as the time it takes to achieve 95% of the complete mixing greyscale value.

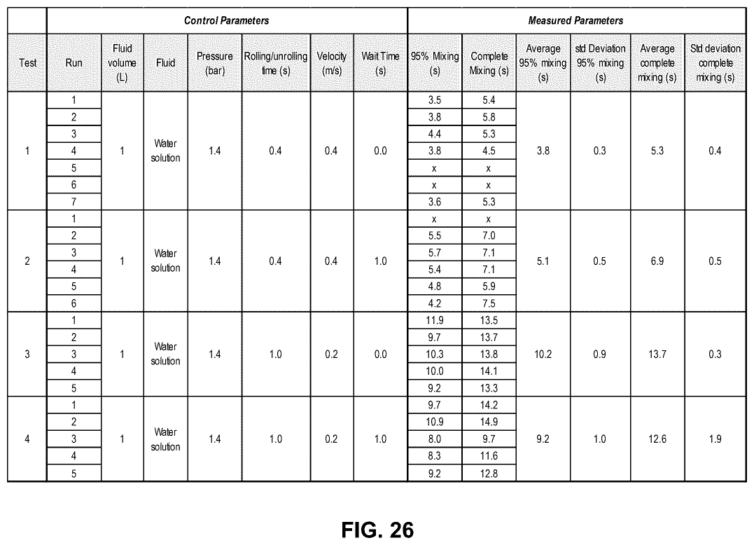

FIG. 26 shows an exemplary data table of measured mixing times as a function of actuation cycle properties for mixing systems using pneumatic rolling actuators, as shown in FIGS. 21A-21C. The data presented in the table suggests that reasonable mixing times may be achieved through variations in control properties.

It should be appreciated that the aforementioned processes of mixing efficiency evaluation is exemplary, and that other analysis processes to evaluate the mixing efficiency of the mixing systems herein are contemplated.

The above-described embodiments of the technology described herein can be implemented in any of numerous ways. For example, the embodiments may be implemented using hardware, software or a combination thereof. When implemented in software, the software code can be executed on any suitable processor or collection of processors, whether provided in a single computing device or distributed among multiple computing devices. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format.

Further, it should be appreciated that a computing device may be embodied in any of a number of forms, such as a rack-mounted computer, a desktop computer, a laptop computer, or a tablet computer. Additionally, a computing device may be embedded in a device not generally regarded as a computing device but with suitable processing capabilities, including a Personal Digital Assistant (PDA), a smart phone, tablet, or any other suitable portable or fixed electronic device.

Also, a computing device may have one or more input and output devices.

These devices can be used, among other things, to present a user interface. Examples of output devices that can be used to provide a user interface include display screens for visual presentation of output and speakers or other sound generating devices for audible presentation of output. Examples of input devices that can be used for a user interface include keyboards, individual buttons, and pointing devices, such as mice, touch pads, and digitizing tablets. As another example, a computing device may receive input information through speech recognition or in other audible format.

Such computing devices may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the embodiments described herein may be embodied as a computer readable storage medium (or multiple computer readable media) (e.g., a computer memory, one or more floppy discs, compact discs (CD), optical discs, digital video disks (DVD), magnetic tapes, flash memories, RAM, ROM, EEPROM, circuit configurations in Field Programmable Gate Arrays or other semiconductor devices, or other tangible computer storage medium) encoded with one or more programs that, when executed on one or more computers or other processors, perform methods that implement the various embodiments discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computing devices or other processors to implement various aspects of the present disclosure as discussed above. As used herein, the term “computer-readable storage medium” encompasses only a non-transitory computer-readable medium that can be considered to be a manufacture (i.e., article of manufacture) or a machine. Alternatively or additionally, the disclosure may be embodied as a computer readable medium other than a computer-readable storage medium, such as a propagating signal.

The terms “program” or “software” are used herein in a generic sense to refer to any type of computer code or set of computer-executable instructions that can be employed to program a computing device or other processor to implement various aspects of the present disclosure as discussed above. Additionally, it should be appreciated that according to one aspect of this embodiment, one or more computer programs that when executed perform methods of the present disclosure need not reside on a single computing device or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

The embodiments described herein may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Further, some actions are described as taken by a “user.” It should be appreciated that a “user” need not be a single individual, and that in some embodiments, actions attributable to a “user” may be performed by a team of individuals and/or an individual in combination with computer-assisted tools or other mechanisms.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

While several embodiments of the present disclosure have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used. Those skilled in the art will recognize, or be able to ascertain using no more than routine experimentation, many equivalents to the specific embodiments of the disclosure described herein. It is, therefore, to be understood that the foregoing embodiments are presented by way of example only and that, within the scope of the appended claims and equivalents thereto, the disclosure may be practiced otherwise than as specifically described and claimed. The present disclosure is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

Any terms as used herein related to shape, orientation, alignment, and/or geometric relationship of or between, for example, one or more articles, structures, forces, fields, flows, directions/trajectories, and/or subcomponents thereof and/or combinations thereof and/or any other tangible or intangible elements not listed above amenable to characterization by such terms, unless otherwise defined or indicated, shall be understood to not require absolute conformance to a mathematical definition of such term, but, rather, shall be understood to indicate conformance to the mathematical definition of such term to the extent possible for the subject matter so characterized as would be understood by one skilled in the art most closely related to such subject matter.

1. A mixing device comprising:
a container configured to contain a fluid; and
a mixer disposed in the container, wherein the mixer includes:
a substrate,
a plurality of slots arranged in a pattern on the substrate, wherein the plurality of slots define one or more spines extending at least partially along an axial direction of the substrate, and
a plurality of flaps, wherein the plurality of flaps are configured to move between an extended configuration and a retracted configuration when the substrate is deformed in the axial direction,
wherein the plurality of flaps are configured to induce flow in the fluid when the substrate is deformed in the axial direction.

2. (canceled)

3. The mixing device of claim 1, wherein the container comprises a seam extending along a perimeter of the container, wherein the mixer is attached to the container at the seam.

4. (canceled)

5. The mixing device of claim 1, wherein the plurality of flaps are configured to be co-planar with the substrate in the retracted configuration.

6. The mixing device of claim 1, wherein the plurality of flaps are configured to extend out of a plane of the substrate in the extended configuration.

7. The mixing device of claim 6, wherein the mixer is a first mixer, wherein the mixing device further comprises a second mixer comprising a plurality of flaps, wherein the plurality of flaps are configured to move between an extended configuration and a retracted configuration when a substrate of the second mixer is deformed in the axial direction, and wherein the plurality of flaps of the second mixer are configured to extend out of a plane of the substrate of the second mixer in a direction different from the plurality of flaps of the first mixer.

8-10. (canceled)

11. The mixing device of claim 1, wherein the mixer further comprises a plurality of paddles extending from the substrate.

12. The mixing device of claim 8, wherein at least one of the mixer and the one or more actuators is formed in a fractal structure.

13. A mixing device comprising:
a container configured to contain a fluid; and
a mixer disposed in the container, wherein the mixer is configured to induce flow in the fluid contained in the container when the mixer is deformed in an axial direction, wherein the mixer comprises a plurality of flaps, the plurality of flaps configured to move between a retracted configuration and an extended configuration when the mixer is deformed in the axial direction.

14. (canceled)

15. The mixing device of claim 13, wherein the plurality of flaps are configured to be co-planar with a substrate of the mixer in the retracted configuration.

16. The mixing device of claim 13, wherein the plurality of flaps are configured to extend out of a plane of a substrate of the mixer in the extended configuration.

17-18. (canceled)

19. A method of mixing a fluid disposed inside of a container, the method comprising:
displacing opposing end portions of a mixer disposed in the container relative to each other to deform the mixer and induce flow in the fluid,
further comprising moving a plurality of flaps of the mixer between an extended configuration and a retracted configuration when the mixer is deformed to induce flow in the fluid.

20. (canceled)

21. The method of claim 19, wherein the plurality of flaps are co-planar with the mixer in the retracted configuration.

22. The method of claim 19, wherein the plurality of flaps extend out of a plane of a substrate of the mixer in the extended configuration.

23-26. (canceled)

27. A mixing system comprising:
a container configured to contain a fluid;
a mixer disposed in the container; and
an actuator disposed in the container and operatively coupled to the mixer, wherein the actuator is configured to axially deform the mixer to induce flow in the fluid contained in the container.

28-31. (canceled)

32. The mixing system of claim 27, wherein the actuator comprises one or more bladders configured to be inflated to place the mixer in a retracted configuration, and wherein the one or more bladders are configured to be deflated to place the mixer in an extended configuration.

33. The mixing system of claim 27, wherein the actuator comprises a plurality of bladders.

34. The mixing system of claim 27, wherein the actuator comprises an inflatable tube configured to axially inflate to place the mixer in an extended configuration, and wherein the inflatable tube is configured to axially deflate to place the mixer in a retracted configuration.

35-43. (canceled)

44. The mixing system of claim 27, wherein the actuator comprises an energy storage member coupled to a bladder, wherein the energy storage member and the bladder are configured to transition between a rolled and unrolled configuration upon actuation.

45-47. (canceled)

48. A mixing system comprising:
a container configured to contain a fluid;
a mixer disposed in the container, wherein the mixer is operatively coupled to a first portion of the container; and
an actuator disposed in the container, wherein the actuator is operatively coupled to a second portion of the container and the mixer, wherein the actuator is configured to deform the mixer to induce flow in the fluid contained in the container.

49. The mixing system of claim 48, wherein the mixer comprises a plurality of flaps, wherein the plurality of flaps is configured to move between an extended configuration and a retracted configuration when the mixer is axially deformed, and wherein the plurality of flaps is configured to induce flow in the fluid when the mixer is axially deformed.

50-55. (canceled)

56. A method of mixing a fluid disposed inside of a container, the method comprising:
axially deforming an actuator disposed in the container to axially deform a mixer disposed in the container; and
inducing flow in the fluid disposed in the container when the mixer is axially deformed.

57. The method of claim 56, wherein inducing flow in the fluid comprises moving a plurality of flaps between an extended configuration and a retracted configuration when the mixer is axially deformed.

58. The method of claim 56, further comprising:
inflating one or more bladders of the actuator to axially extend the mixer; and
deflating the one or more bladders of the actuator to axially retract the mixer.

59-63. (canceled)

64. The method of claim 56, wherein the actuator further comprises a plurality of paddles extending from at least one of the actuator and the mixer.

65. (canceled)

66. A method of mixing a fluid disposed inside of a container, the method comprising:
introducing fluid into a bladder of an actuator disposed in the container;
unrolling the actuator; and
inducing flow in the fluid disposed in the container when the actuator is unrolled.

67-69. (canceled)
